(19) United States
(12) Patent Application Publication
(10) Pub. No.: US 2026/0231127 A1
(43) Pub. Date: Aug. 6, 2026

(54) VARIABLE-BANDWIDTH ALLOCATION FOR FREQUENCY DIVISION MULTIPLEXED BACKSCATTER COMMUNICATIONS

(71) Applicant: QUALCOMM Incorporated, San Diego, CA (US)

(72) Inventors: Raviteja PATCHAVA, San Diego, CA (US); Piyush GUPTA, Bridgewater, NJ (US); Junyi LI, Greentown, PA (US)

(21) Appl. No.: 19/046,013

(22) Filed: Feb. 5, 2025

(51) Int. Cl. H04W 72/0453; H04W 4/80; H04W 72/541; H04W 74/0833

(52) U.S. Cl. CPC H04W 72/0453; H04W 72/541; H04W 74/0833; H04W 4/80

(57) ABSTRACT

Certain aspects of the present disclosure provide techniques for backscatter communications. A method, by an apparatus (e.g., such as a reader, or a wireless communications device that is capable of wirelessly communicating with an internet-of-things (IoT) device) generally includes receiving, from a first IoT device, a first random access message; and sending, to the first IoT device, a second random access message that indicates: a first frequency shift for a transmission of a third random access message, wherein the first frequency shift is based on a first signal-to-noise ratio (SNR) associated with the first random access message; and a first bandwidth allocation for the transmission of the third random access message, wherein the first bandwidth allocation is based on the first frequency shift and the first SNR.

### INTRODUCTION

### FIELD OF THE DISCLOSURE

Aspects of the present disclosure relate to wireless communications, and more particularly, to techniques for backscatter communications.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a reader. The method includes receiving, from a first internet-of-things (IoT) device, a first random access message; and sending, to the first IoT device, a second random access message that indicates: a first frequency shift for a transmission of a third random access message, wherein the first frequency shift is based on a first signal-to-noise ratio (SNR) associated with the first random access message; and a first bandwidth allocation for the transmission of the third random access message, wherein the first bandwidth allocation is based on the first frequency shift and the first SNR.

Certain aspects provide a method for wireless communications by a first IoT device. The method includes sending a first random access message; receiving a second random access message that indicates: a first frequency shift for a transmission of a third random access message, wherein the first frequency shift is based on a first SNR associated with the first random access message; and a first bandwidth allocation for the transmission of the third random access message, wherein the first bandwidth allocation is based on the first frequency shift and the first SNR; and sending the third random access message based on the first frequency shift and in the first bandwidth allocation.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts example components of an energy harvesting-capable Internet-of-Things (IoT) device.

FIG. 6 depicts aspects relating to different radio frequency (RF) energy harvesting and RF communication architectures for an energy harvesting-capable device.

FIG. 7A depicts an example monostatic system.

FIG. 7B depicts an example multi-static system.

FIG. 7C depicts another example multi-static system.

FIG. 8A depicts a process flow for an example inventory procedure.

FIG. 8B depicts a process flow for another example inventory procedure.

FIG. 9 depicts example harmonic composition of a square wave.

FIG. 10 depicts example interference resulting from a sampling frequency offset (SFO) between wireless devices.

FIG. 11 depicts a process flow for communications in a network between reader and multiple IoT devices for variable bandwidth determination and allocation.

FIG. 12 depicts example frequency shifts and bandwidths, which may be allocated to different IoT devices for backscatter communications.

FIG. 13 depicts example bandwidth allocation for backscatter communication at four IoT devices.

FIG. 14 depicts example bandwidth allocation for backscatter communication at three IoT devices.

FIG. 15 depicts example scheduling of IoT device backscatter communications utilizing variable bandwidths.

FIG. 16 depicts a method for wireless communications.

FIG. 17 depicts another method for wireless communications.

FIG. 18 depicts aspects of an example communications device.

FIG. 19 depicts aspects of an example communications device.

### DETAILED DESCRIPTION

Aspects of the present disclosure provide apparatuses, methods, processing systems, and computer-readable mediums for allocating variable bandwidth to internet-of-things (IoT) devices (e.g., such as ambient IoT devices, described in detail below) for frequency-division multiplexed (FDMed) backscatter communications. As used herein “FDMed backscattered communications” may refer to the simultaneous transmission of multiple backscattered signals, where each signal is frequency-shifted to occupy a distinct frequency band of a communications channel.

Certain wireless communications systems (e.g., an Evolved Universal Terrestrial Radio Access (E-UTRA) system, 5G New Radio (NR) system, and/or any future wireless communication system) may enable access to network services using a physical layer configured for very low power consumption and low complexity, which may be beneficial for certain devices operating on battery power and/or utilizing power harvesting circuitry, such as IoT devices. IoT devices generally refer to physical objects or “things,” which collect and exchange data with other devices and systems over the Internet. IoT extends internet connectivity beyond typical computing devices (e.g., such as desktops, laptops, smartphones, tablets, etc.) to any range of traditionally non-internet-enabled physical devices and/or everyday objects. For example, IoT devices may include non-standard computing hardware (e.g., such as tags, sensors, actuators, wearables, gadgets, appliances, machines, etc.) that are programmed for certain applications, can connect wirelessly to a network, and are able to transmit data. Further, IoT devices may include, or may be embedded into, devices such as mobile devices, industrial equipment, environmental sensors, and/or medical devices, such as to enable (1) the communication of those devices over the Internet and/or the (2) the remote monitoring and/or control of such devices.

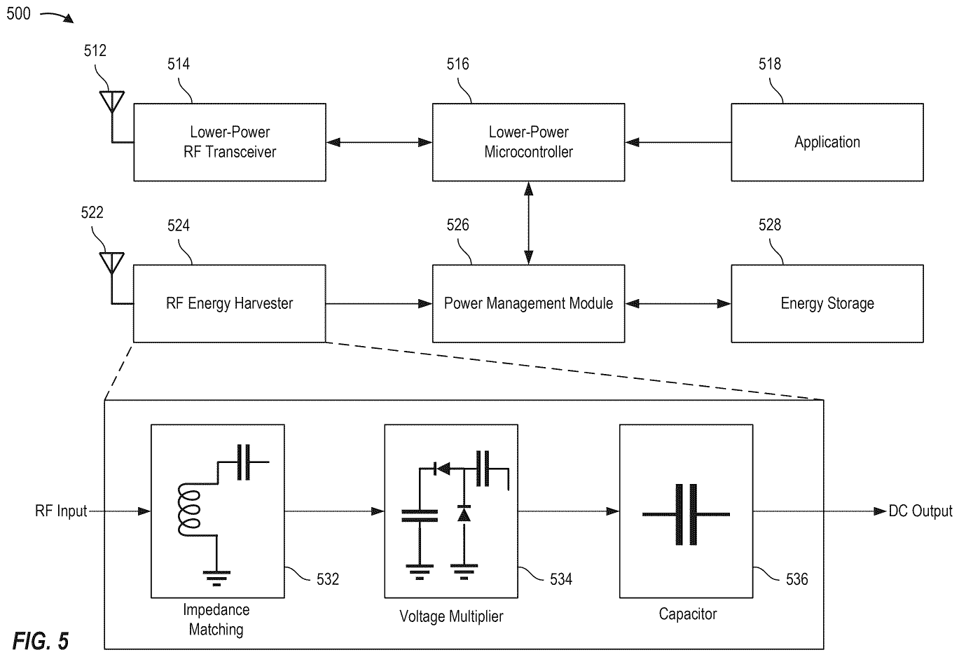

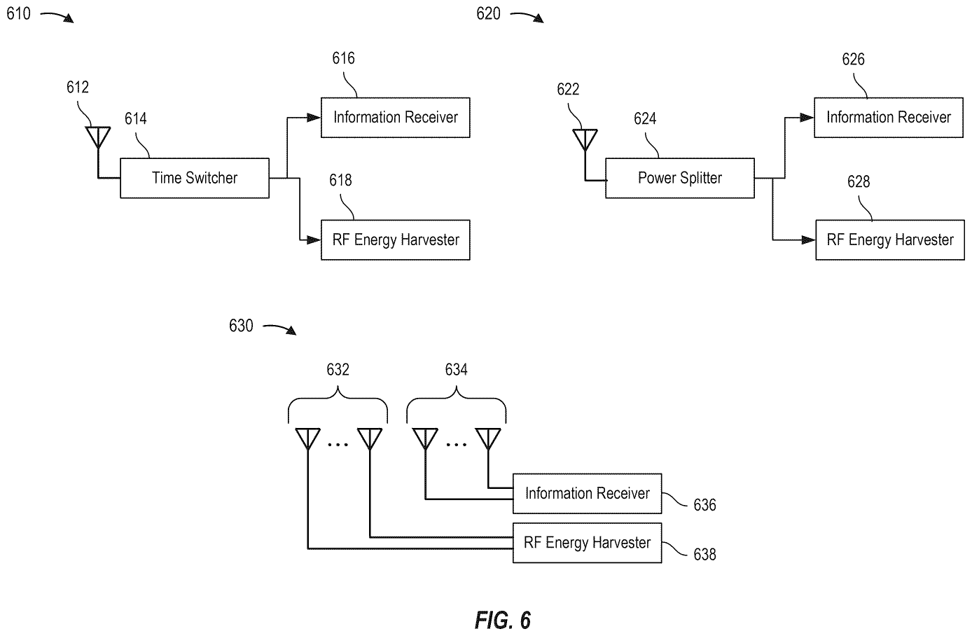

A class of IoT devices may include ambient IoT devices, which may have ultra-low complexity, ultra-low power consumption, a small form factor (e.g., a thickness of about 1 millimeter), and/or a long life cycle. In certain cases, an ambient IoT device may be battery-less and/or have relatively small energy storage capacity (e.g., a capacitor or small battery). Ambient IoT devices may include active IoT devices, semi-passive IoT devices, and/or passive IoT devices, as further described herein with respect to FIGS. 5 and 6. An ambient IoT device may be a self-powered device that is capable of active transmission and/or passive backscattering of radio frequency (RF) signals, for example, through energy harvesting, in order to prolong the operational life of the device and enable minimal or no human intervention.

As an illustrative example, an ambient IoT device may communicate by backscattering RF signals received from an energy exciter. Note that terms “energy exciter,” “energy source,” “energizer,” “illuminator,” “activator,” or the like may be used interchangeably. As an example, the energy exciter may transmit an energy excitation signal, such as an RF signal having a continuous waveform (e.g., a sinusoidal waveform). The ambient IoT device may receive the RF signal from the energy exciter, modulate information on the received signal, and reflect the modulated RF signal to a reader. Such a process may be referred to as backscattering or backscatter communications. A backscatter device may refer to a device that is capable of backscatter communications. A backscatter device may be or include a semi-passive IoT device, and/or a passive IoT device. As used herein, a reader may refer to a wireless communications device that is capable of wirelessly communicating with an IoT device such as an ambient IoT device. As an example, the reader may be or include a user equipment (UE), a network node (e.g., a base station, access point, and/or a disaggregated entity thereof), or any suitable wireless communications device. The reader may function as an energy exciter. Further, it should be understood that, unless otherwise specifically stated, terms such as “reader,” “radio frequency identification (RFID) reader,” “tag reader,” and the like are intended to be interchangeable.

The Third Generation Partnership Project (3GPP) defines various use cases, or application scenarios, for ambient IoT devices including, for example, the use of ambient IoT devices for indoor inventory (e.g., a first representative use case (rUC1)), the use of ambient IoT devices as indoor sensors (e.g., a second rUC (rUC2)), the use of ambient IoT devices for indoor positioning (e.g., a third rUC (rUC3)), the use of ambient IoT devices for indoor command (e.g., a fourth rUC (rUC4)), the use of ambient IoT devices for outdoor inventory (e.g., a fifth rUC (rUC5)), the use of ambient IoT devices as outdoor sensors (e.g., a sixth rUC (rUC6)), the use of ambient IoT devices for outdoor positioning (e.g., a seventh rUC (rUC7)), and the use of ambient IoT devices for outdoor command (e.g., an eighth rUC (rUC8)). The inventory use cases (also referred to herein as “inventory procedures”), specifically rUC1 and rUC5, may generally include gathering inventory information from one or more A-IoT devices, such as to track and monitor inventory in real-time. Indoor and/or outdoor inventory using A-IoT devices may be implemented for automated warehousing, medical instruments inventory management and positioning, logistics of non-public networks, automobile manufacturing, and/or automated supply chain distribution, among other applications.

As described herein, a reader and an ambient IoT device may perform a random access procedure to enable one of the aforementioned use cases and/or enable communications between the ambient IoT device and the reader. For example, the reader and the ambient IoT device may perform the random access procedure to enable an inventory procedure, and more specifically, enable the reader to query the ambient IoT device for certain information.

In general, a random access procedure may involve the reader first sending a query message (MSG0) (also commonly referred to as a “trigger message”), to the ambient IoT device. The query message (MSG0) may trigger the ambient IoT device to perform the random access procedure, as well as, in some cases, perform one of the aforementioned use cases, such as an inventory procedure. For example, the ambient IoT device may send a first random access message (MSG1) in response to the query message (MSG0). In certain aspects, the ambient IoT device may receive a first waveform from the reader or another wireless device, which may activate the ambient IoT device (e.g., activate one or more radio frequency (RF) chains or components of the ambient IoT device) to send a backscattered signal of the first waveform modulated with data, such as for example, a first random access message (MSG1). The data associated with the first random access message (MSG1) may include at least an identifier (ID) associated with the ambient IoT device. The reader may respond to the ambient IoT device by sending a second random access message (MSG2). In certain aspects, the second random access message (MSG2) may include the ID associated with the ambient IoT device (e.g., the reader may echo the ID associated with the ambient IoT device in MSG2). In certain aspects, the second random access message (MSG2) may further indicate time resource(s) and frequency resource(s) scheduled for sending a third random access message (MSG3). Based on the second random access message (MSG2) including the ID associated with the ambient IoT device, the ambient IoT device may send the third random access message (MSG3), to the reader, via the indicated time resource(s) and frequency resource(s). For example, in certain aspects, the ambient IoT device may receive a second waveform from the reader or another wireless device, which may activate the ambient IoT device to send a backscattered signal of the second waveform modulated with data, such as for example, the third random access response (MSG3), to the reader via the indicated time resource(s) and frequency resource(s). The data associated with the third random access message (MSG3) may include (1) a device ID for the ambient IoT device (e.g., configured or assigned ID for the ambient IoT device, such as an electronic product code (EPC) ID) and/or (2) information corresponding to an ambient IoT use case, such as inventory information for an indoor or outdoor inventory procedure and/or other information for a different use case.

In some cases, the reader may trigger multiple ambient IoT devices to perform a random access procedure, such as to enable an inventory procedure for the multiple ambient IoT devices. For example, the reader may send the query message (MSG0) to multiple ambient IoT devices (e.g., the MSG0 may be broadcasted to multiple ambient IoT devices), where the query message (MSG0) triggers the random access procedure (or inventory procedure) for the multiple ambient IoT devices. Each ambient IoT device of the multiple ambient IoT devices, or a subset of the multiple ambient IoT devices, may communicate with the reader, to perform the random access procedure (and inventory procedure), based on sending a respective first random access message (MSG1), receiving a respective second random access message (MSG2) indicating time resource(s) and frequency resource(s) scheduled for sending a respective third random access message (MSG3), and sending the respective third random access message (MSG3).

Technical problems associated with the use of backscatter communications when performing a random access procedure between a reader and one or more ambient IoT devices, such as to enable an inventory procedure for the one or more ambient IoT devices, may include, for example, interference mitigation. Specifically, during a random access procedure (or more specifically, an inventory procedure), a reader may experience self-interference based on simultaneously attempting to transmit and receive signals using a same frequency. Additionally, or alternatively, an ambient IoT device may experience interference from other ambient IoT device(s) based on the ambient IoT devices transmitting backscattered signals at the same time.

For example, during a random access procedure, an ambient IoT device may receive a waveform, which may activate the ambient IoT device to send a backscattered signal of the waveform modulated with data. As described above, the backscattered signal may include the first random access message (MSG1) or the third random access message (MSG3) of the random access procedure. In certain aspects, the wireless device that sends the waveform to the ambient IoT device is a reader, which also receives the first random access message (MSG1) and the third random access message (MSG3) from the ambient IoT device. The reader may be a “full-duplex device” that is capable of bi-directional network transmissions at the same time. Thus, in certain aspects, a backscattered signal (e.g., the first random access message (MSG1) or the third random access message (MSG3)) sent to the reader may interfere with one or more other concurrent transmissions of the reader (e.g., such as the original signal sent by the reader), thereby resulting in self-interference at the reader.

One strategy to mitigate self-interference at the reader is through frequency shifting. “Frequency shifting” in the context of backscattering may refer to a technique where an ambient IoT device modifies the frequency of a backscattered signal (e.g., MSG1 or MSG3), which is returned to a reader. For example, the ambient IoT device may shift a frequency of the backscattered signal relative to a frequency of the received waveform (e.g., from the reader) to reduce self-interference at the reader. In certain aspects, the ambient IoT device may use square wave modulation to modulate the backscattered signal as a square wave, thereby causing the backscattered signal's frequency to shift relative to the received waveform. A “square wave” is a non-sinusoidal periodic waveform in which the amplitude alternates at a steady frequency between fixed minimum and maximum values, with the same duration at minimum and maximum values. A square wave may shift the frequency from a first channel (e.g., where the waveform is received) to an adjacent second channel (e.g., where the waveform is backscattered), such as to reduce interference between the transmitted waveform from the reader and the backscattered signal from the ambient IoT device.

While square wave modulation provides an efficient way to encode and shift the frequency of backscattered signals from an ambient IoT device, such as to help reduce self-interference at a reader and improve communication between the reader the ambient IoT device, square wave modulation may produce interference at some harmonics, such as odd harmonics. For instance, a square wave may be equivalent to a sine wave at a same (fundamental) frequency that is added to an infinite series of odd harmonics (e.g., sine-wave harmonics) at decreasing amplitudes. As an example, odd harmonics of a square wave with a fundamental frequency of “f” may include 3f (e.g., three times the fundamental frequency), 5f, 7f, and so on out to infinity. The odd harmonics of the square wave may cause energy peaks in adjacent frequency bands, and thus in some cases, cause unwanted interference to other ambient IoT devices. For example, multiple ambient IoT devices may transmit backscattered square waves concurrently, such as during a random access procedure used to enable an inventory procedure for the multiple ambient IoT devices. The harmonics associated with each ambient IoT device's transmitted square wave may result in interference between the multiple ambient IoT devices, thereby degrading communications quality and efficiency.

In some cases, a reader may reduce interference between ambient IoT devices, which utilize square wave modulation for backscattering (e.g., such as during a random access procedure, or more specifically, an inventory procedure), based on assigning frequency shifts to the ambient IoT devices that do not interfere with each other. That is, a reader may assign frequency shifts of {Δf, 4Δf, 8Δf, 16Δf . . . } to ambient IoT devices such that (1) interference from the odd harmonics of each respective frequency-shifted backscattered signal from each respective ambient IoT device is reduced and (2) interference due to sampling frequency offset (SFO) between the reader and each respective ambient IoT device (e.g., a mismatch between their sampling frequencies or their respective oscillators) is reduced (or minimized). As described herein, an ambient IoT device that is assigned a frequency shift of Δf may modulate a backscattered signal as a square wave with a frequency shift of Δf relative to a received waveform, an ambient IoT device assigned a frequency shift of 4Δf may modulate a backscattered signal as a square wave with a frequency shift of 4Δf relative to a received waveform, and so on.

Each frequency shift {Δf, 4Δf, 8Δf, 16Δf . . . } supported by the reader for backscatter communications, and assigned to the ambient IoT devices, may correspond to a frequency of a respective bandwidth (e.g., a range of frequencies that a signal may occupy). While the respective bandwidth associated with each frequency shift may be associated with different minimum and maximum frequencies, the frequency range of each respective bandwidth may be the same. As an illustrative example, a Δf frequency shift (e.g., such as 30 kilohertz (KHz)) may correspond to a frequency of a first bandwidth occupying frequencies from X KHz to X+15 KHz (e.g., a 15 KHz bandwidth), while a 4Δf frequency shift may correspond to a frequency of a first bandwidth occupying frequencies from Y KHz to Y+15 KHz (e.g., also a 15 KHz bandwidth). Thus, frequency shifts {Δf, 4Δf, 8Δf, 16Δf . . . } may be allocated to the ambient IoT devices with the same bandwidth allocation, such that backscattered signals from each ambient IoT device utilize/occupy a same frequency range width.

Allocating the same bandwidth (e.g., same frequency range width) to different ambient IoT devices for backscattered communication of different frequency-shifted signals (e.g., such as during a random access procedure, or more specifically, an inventory procedure) may result in under-utilization of the available frequency spectrum. For example, frequency shifts being allocated with the same bandwidth, such as for backscatter communications, may lead to portions of the spectrum (e.g., gaps between the allocated frequency ranges) being unused, or put differently, may result in wasted resources. Inefficient spectrum usage may reduce the overall capacity of the wireless network and/or lower spectral efficiency, which may adversely impact network performance and/or overall user experience. For example, the reduced network capacity and spectral efficiency may result in increased latency due to longer transmission times, network congestion and/or bottlenecks, and/or the inability to support new technologies (e.g., such as IoT devices), among other bad outcomes.

Certain aspects described herein overcome the aforementioned technical problems and provide a technical benefit to the field of telecommunications. In particular, certain aspects provide techniques for allocating variable bandwidth to IoT devices (e.g., ambient IoT devices) for FDMed backscatter communications. “Variable bandwidth allocation” may refer to bandwidth allocation that may change per IoT device (e.g., a first IoT device may be allocated 20 MHz, a second IoT device may be allocated 40 MHz, etc.). For example, a reader may assign different frequency shifts (e.g., frequency shifts of {Δf, 4Δf, 8Δf, 16Δf...}) to different IoT devices for backscattering signals to the reader. Additionally, the reader may allocate different bandwidths (e.g., different frequency range widths, such as 20 MHz vs 50 MHz, no matter where the frequency is) to the different IoT devices for the transmissions of the backscattered signals. Each IoT device may modulate a backscattered signal using the respective frequency shift assigned to the respective IoT device, and send the modulated signal, via backscattering, in the respective bandwidth allocated to the respective IoT device.

In certain aspects, the bandwidth allocated to different IoT devices may be based on a respective signal-to-noise ratio (SNR) associated with each IoT device. The SNR associated with an IoT device may represent the quality and/or reliability of a signal backscattered by the IoT device. For example, in certain aspects, the reader may allocate greater bandwidth (e.g., larger frequency range widths) to IoT devices associated with higher SNRs than other IoT devices. Further, the reader may allocate less bandwidth (e.g., smaller frequency range widths) to IoT devices associated with lower SNRs than other IoT devices. In certain aspects, higher SNR IoT devices may include IoT devices that are positioned nearby the reader, while lower SNR IoT devices may include IoT devices that are positioned farther away from the reader. In certain aspects, the reader may also allocate higher SNR devices with higher frequency shifts (e.g., such as 8Δf and 16Δf) and lower SNR devices with lower frequency shifts (e.g., such as Δf and 4Δf) for backscattering.

In certain aspects, the variable bandwidth may be allocated to different IoT devices, such as different ambient IoT devices, for backscattering signals during a random access procedure. In certain aspects, the random access procedure may enable an inventory procedure between a reader and the different ambient IoT devices. For example, during the random access procedure/inventory procedure, the reader may send a second random access signal (MSG2) (e.g., described in detail above) to each ambient IoT device. Each second random access signal (MSG2) may indicate, to an ambient IoT device receiving the random access signal (MSG2), a respective frequency shift and a respective bandwidth allocation to use for the transmission of a respective third random access signal (MSG3) (e.g., described in detail above), such as via backscattering. The frequency shift and bandwidth allocated to different ambient IoT devices may be different. Further, the frequency shift and the bandwidth allocated to the different ambient IoT devices may be based on a respective SNR associated with each ambient IoT device.

Although certain examples herein are described with respect to variable bandwidth allocation for FDMed backscattered communications from ambient IoT devices, it is noted that the techniques may be similarly applied to backscattered communications from other wireless devices. Further, although certain examples herein are described with respect to variable bandwidth allocation for random access procedure backscattered communications (or inventory procedure backscattered communications), it is noted that the techniques may be similarly applied to backscattered communications for various other purposes.

Certain techniques for backscatter communication, and more specifically variable bandwidth allocation for FDMed backscatter communication, described herein may provide various beneficial technical effects and/or advantages. The techniques for variable bandwidth allocation may enable improved wireless communications performance, such as increased network capacity and improved spectral efficiency. The improved wireless communication performance may be attributable to the more efficient utilization of the frequency spectrum, especially for higher frequency shifts, due to allocating different bandwidths to different IoT devices (e.g., which are assigned different frequency shifts) for backscatter communications. In certain aspects, the more efficient utilization of the frequency spectrum may be achieved based on using the variable bandwidth allocation techniques described herein, while also reducing interference to a reader and/or between IoT devices.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

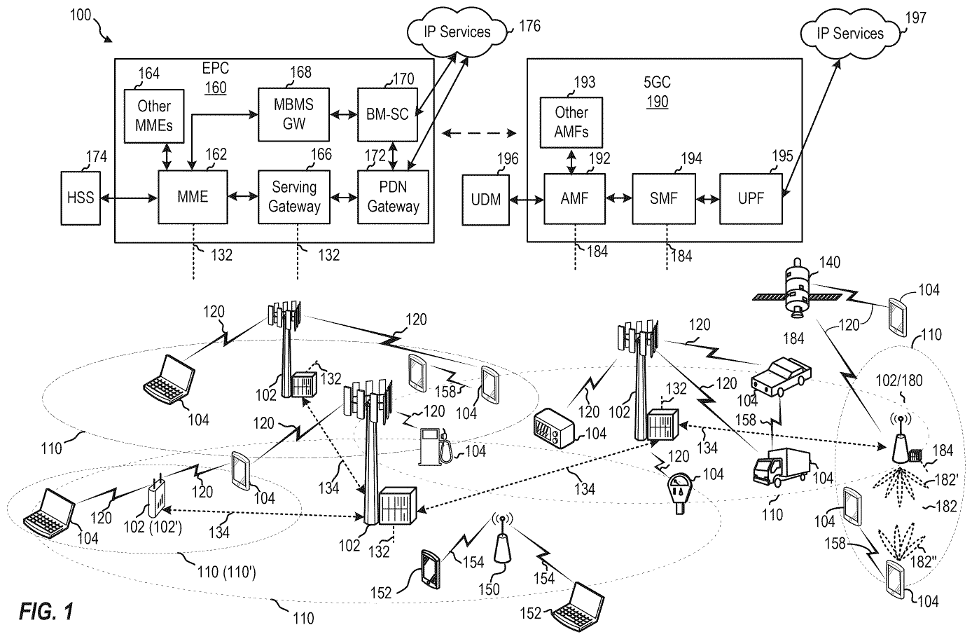

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

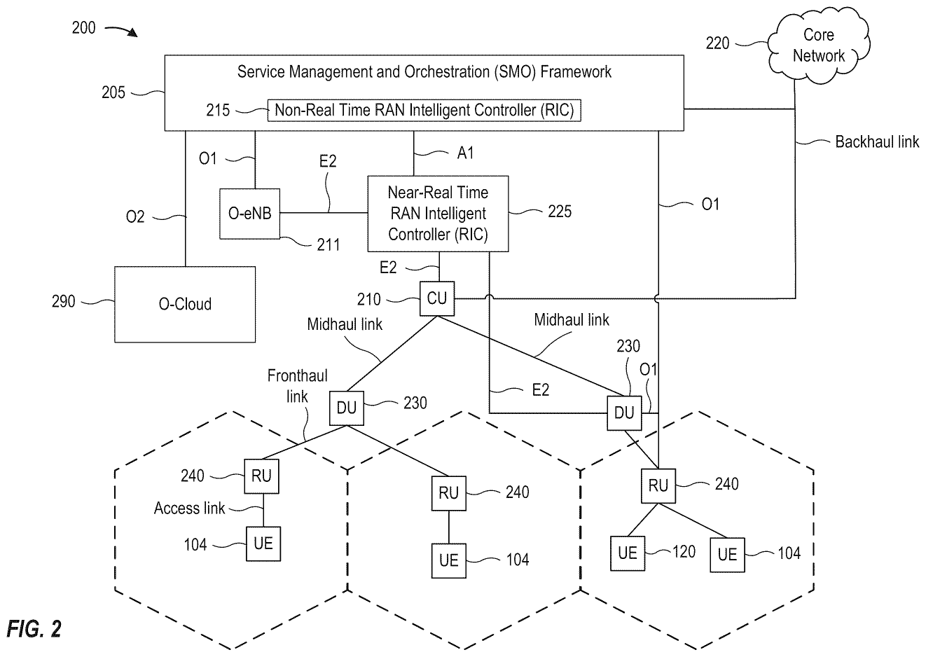

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S 1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR 1) as including 410 MHz- 7125 MHz, which is often referred to (interchangeably) as “Sub- 6 GHz”. Similarly, 3GPP currently defines Frequency Range 2 (FR 2) as including 24,250 MHz- 71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz- 52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182′′. UE 104 may also transmit a beamformed signal to the BS 180 in one or more transmit directions 182′′. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

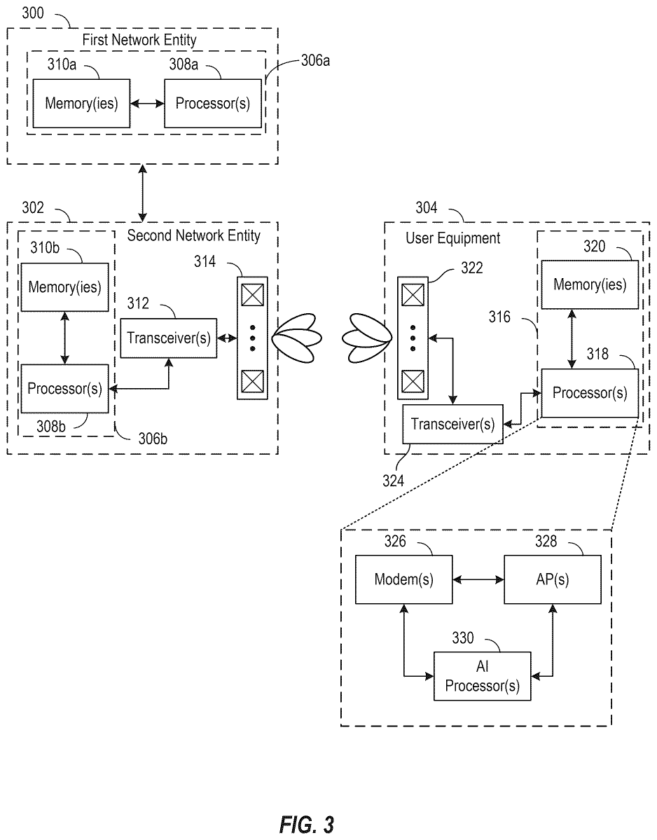

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

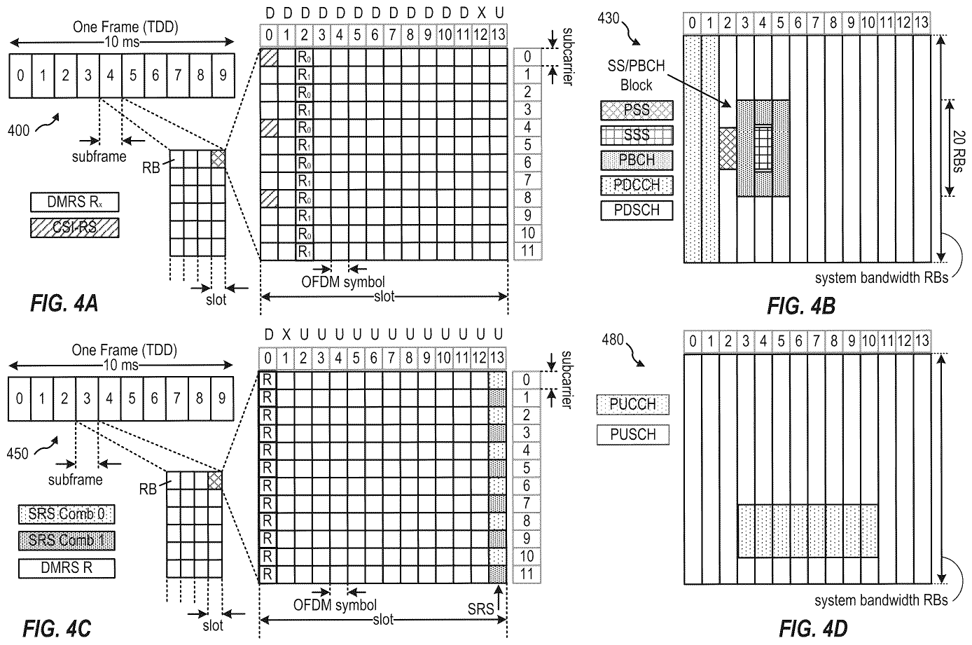

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ}slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2μ×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Ambient IoT Devices

Ambient IoT devices may include several device subclasses, including active IoT devices, semi-passive IoT devices, and passive IoT devices. Ambient IoT devices are generally capable of operating based on energy harvested from the ambient environment, such as from received RF energy, solar energy, vibrational energy, and/or the like.

An active IoT device is generally capable of harvesting ambient energy as well as using energy stored onboard the device, such as through a battery or capacitor. An active IoT device generally includes both active radio equipment (e.g., an active radio) and passive radio equipment (e.g., a backscatter-type radio). A backscatter-type radio uses existing radio frequency signals to transmit data by modifying (e.g., modulating) and reflecting received signals with encoded data. Capabilities of an active IoT device may thus be similar to other types of UEs with the addition of energy harvesting capabilities.

A semi-passive (or semi-active) IoT device is generally capable of harvesting ambient energy as well as using energy stored onboard the device, and likewise generally includes both active radio equipment and passive radio equipment, like a backscatter-type radio. In some cases, semi-passive IoT devices may be capable of synchronous (e.g., course synchronous) and asynchronous communication. In some cases, semi-passive IoT devices may omit a power amplifier and/or a low-noise amplifier. Further, semi-passive IoT devices may generally use a reduced protocol stack (e.g., compared to an active IoT device). These aspects of semi-passive IoT device generally help to balance power consumption, functionality, and cost. So-called “ultra-light IoT” devices are one type of semi-passive IoT device.

A passive IoT device is generally capable of operating based on energy harvested from the environment using passive radio equipment (e.g., a backscatter-type radio). Passive IoT devices are generally capable of asynchronous communication and may not have a power amplifier or a low-noise amplifier. Passive IoT devices may generally use a reduced protocol stack (e.g., compared to an active IoT device).

FIG. 5 depicts example components 500 of an energy harvesting-capable IoT device (e.g., a UE). Various example components 500 may be incorporated into ambient IoT devices.

In this example, components 512-518 are aspects of a data transmission pipeline. In particular, antenna 512 and RF transceiver 514 (e.g., a low power RF transceiver) may transmit and/or receive data. Microcontroller 516 (e.g., a low power microcontroller) may process data received from an application 518.

Further in this example, components 522-528 are aspects of an RF-energy-harvesting pipeline. In particular, antenna 522 and an RF energy harvester 524 are configured to harvest RF energy. In certain aspects, RF energy harvester 524 includes an impedance matching circuit 532, a voltage multiplier 534, and a capacitor 536 to collect RF signals and convert them into electricity. In certain aspects, a power management module 526 determines whether to store the electricity obtained from the RF energy harvester 524 or to use the electricity for information transmission immediately. In this example, energy storage 528 (e.g., a battery or a capacitor) is configured to store energy converted by the RF energy harvester 524.

As above, in various aspects, an ambient IoT device may include the components depicted and described with respect to FIG. 5. In certain aspects, a passive IoT device may omit certain aspects depicted and described with respect to FIG. 5, such as energy storage 528. Further, while multiple antennas (512 and 522) are depicted in this example, in others, a single antenna and antenna switching component may be used to share the antenna between transceiver 514 and RF energy harvester 524, such as described further with respect to FIG. 6.

FIG. 6 depicts aspects 610, 620, and 630 relating to different RF energy harvesting and RF communication architectures for an energy harvesting-capable device, such as an ambient IoT device.

In particular, aspect 610 depicts antenna 612 connected to time switcher 614. In certain aspects, time switcher 614 is configured to allow an energy harvesting-capable UE to switch between (1) being connected to information receiver 616 and (2) being connected to RF energy harvester 618. For example, the device may exchange wireless communication and RF energy at different, e.g., non-overlapping, times.

Aspect 620 depicts antenna 622 connected to power splitter 624. In certain aspects, power splitter 624 is configured to allow an energy harvesting-capable device to distribute power between (1) information receiver 626 and (2) RF energy harvester 628. Thus, in this example, the device may exchange wireless communication and RF energy at overlapping times. For example, a received RF signal may be split into two streams, with one stream for the information receiver 626 and the other stream for the RF energy harvester 628.

Aspect 630 depicts an example separated receiver architecture. In particular, a first set of antennas 632 is connected with an RF energy harvester 638 and a second set of antennas 1034 is connected with information receiver 636. FIG. 5, described above, depicts a separated receiver architecture.

RF energy may be harvested from various signal types. For example, RF energy may be harvested via one or more of a deterministic signal (e.g., a pilot signal), a random signal (e.g., a circularly symmetric complex Gaussian random signal), and/or an improper complex Gaussian random signal (e.g., a signal in which real and imaginary components have different variances).

### Example Ambient IoT Network Topologies

Wireless communications systems may employ various topologies to communicate with ambient IoT devices, such as backscatter devices. The topologies may include, for example, monostatic and/or multi-static (such as bi-static).

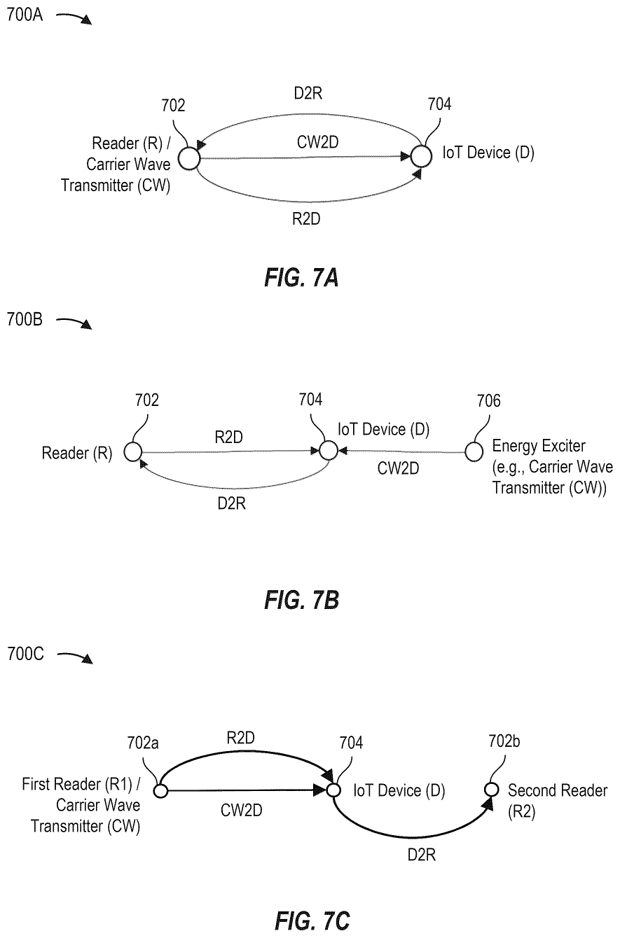

FIG. 7A depicts an example monostatic system 700A. In this example, a reader (R) 702 may perform reader functionalities and energy excitation functionalities. The reader 702 may send an energy excitation signal to an IoT device (D) 704, for example, via a continuous wave transmitter to device (CW2D) link. The reader 702 may send, to the IoT device 704, a first signal that carries information or data via a forward link (e.g., a reader to device (R2D) link). The reader 702 may obtain, from the IoT device 1104, a second signal that carries information or data via a reverse or backward link (e.g., a device to reader (D2R) link). In certain cases, the IoT device 704 may send the second signal by modulating and backscattering the energy excitation signal.

FIG. 7B depicts an example multi-static system 700B. In this example, the multi-static system 700B may include a reader (R) 702 and an energy exciter 706 (e.g., a carrier wave transmitter (CW)). The reader 702 and energy exciter 706 may be separate devices. The multi-static system 700B may be an example of a bi-static system. In certain cases, the energy exciter 706 may not be collocated with the reader 702. For example, the energy exciter 706 may be physically separated from the reader 702. In certain cases, the energy exciter 706 may be or may include a transmitter outside of the topology of the reader 702. As an example, the energy exciter 706 may be or may include an ambient energy source, such as a television tower, radio tower, WiFi access point, or the like. The energy exciter 706 may send an energy excitation to the IoT device (D) 704 via the CW2D link. The reader 702 may communicate with the IoT device 1104 via the R2D link and the D2R link as discussed herein with respect to FIG. 7A.

FIG. 7C depicts another example multi-static system 700C. In this example, a reader may be disaggregated into a transmitter and a receiver. The multi-static system 700C may be another example of a bi-static system. The multi-static system 700C may include a first reader (R1) 702a and a second reader (R2) 702b. The first reader 702a (e.g., a transmitter) may send, to the IoT device (D) 704, a first signal that carries information or data via the R2D link, and the second reader 702b (e.g., a receiver) may obtain, from the IoT device 704, a second signal that carriers information or data via the D2R link. In certain cases, the first reader 702a may serve as an energy source for the IoT device 704. As an example, the first reader 702a may transmit the energy excitation signal to the IoT device 704 via the CW2D link. In certain cases, a separate energy source may be included in the multi-static system 700C, for example, as described herein with respect to FIG. 7B.

### Example Ambient IoT Inventory Procedure

Certain wireless communication systems (e.g., a 5G NR system and/or any future wireless communications system) may provide ambient IoT device services, such as an inventory service or procedure (e.g., the inventory use cases, rUC1 and rUC5, described above). An inventory procedure may allow a reader to query an ambient IoT device for certain information including, for example, asset or device information, a device or asset ID (e.g., an EPC ID), a device or asset state, sensor data or measurements, and/or the like.

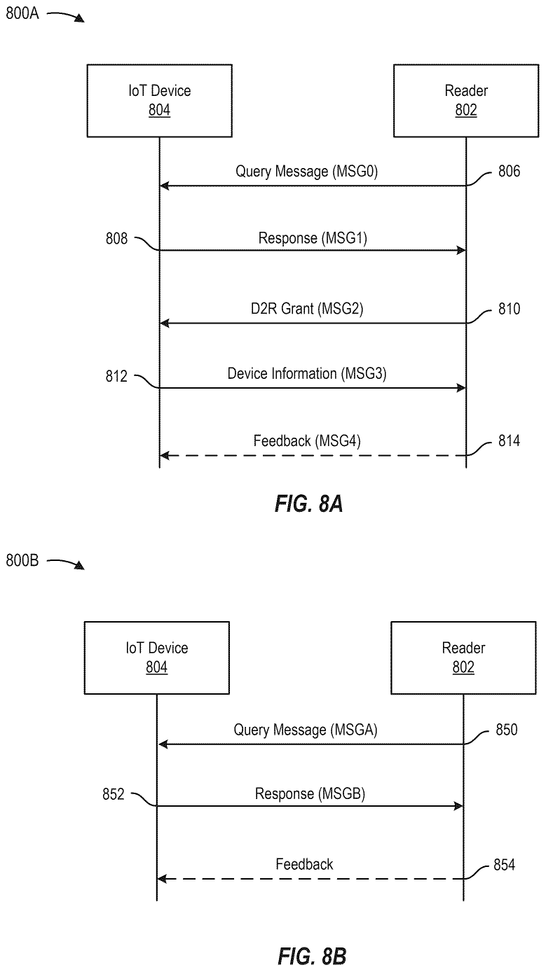

FIG. 8A depicts a process flow diagram of an example inventory procedure 800A performed between an IoT device 804 (e.g., an ambient IoT device) and a reader 802. In certain aspects, the IoT device 804 may be an example of the UE 104 depicted and described with respect to FIG. 1 or the UE 304 depicted and described with respect to FIG. 3. In certain aspects, the IoT device 804 may include any of the energy harvesting architectures described herein with respect to FIGS. 5 and 6. In certain aspects, the reader 802 may be an example of the BS 102 depicted and described with respect to FIGS. 1 and 3 or a disaggregated base station depicted and described with respect to FIG. 2. In certain aspects, the reader 802 may be an example of the UE 104 or the UE 304 depicted and described with respect to FIGS. 1 and 3. In certain aspects, the inventory procedure 800A may include a contention-based random access (CBRA) procedure.

The inventory procedure 800A may begin at 806, where the reader 802 broadcasts, and the IoT device 804 receives, a query message, MSG0 (e.g., ambient IoT MSG0). The query message (MSG0) may request a response from IoT device 804 and that the response includes certain information, such as a device or asset identifier, sensor measurement(s), and/or the like. The query message (MSG0) may indicate communication resource(s) for communication of the response. The communication resource(s) may include time-domain resource(s), frequency-domain resource(s), and/or sequence(s) associated with a spread-spectrum code. The communication resource(s) may be included in a pool of communication resources made available to multiple IoT devices to communicate responses in reply to the query message (MSG0). In certain aspects, the query message (MSG0) may be considered to trigger the IoT device 804 to perform the inventory procedure 800A. Thus, in some cases, the query message (MSG0) may be referred to as a “trigger message” for the inventory procedure 800A.

At 808, the IoT device 804 sends a response (e.g., a random access response), MSG1 (e.g., ambient IoT MSG1), to the reader 802. In certain aspects, the response (MSG1) may be communicated via a physical random access channel (PRACH) in a random access occasion (RO). In certain aspects, the IoT device 804 may receive a first waveform from reader 802 (not shown in FIG. 8A), or another wireless device, which may activate IoT device (e.g., activate one or more RF chains or components of IoT device 804) to send a backscattered signal of the first waveform modulated with data, such as for example, the response (MSG1).

In certain aspects, the response (MSG1) may be communicated based on time division multiplexing (TDM), frequency division multiplexing (FDM), code division multiplexing (CDM), and/or the like. For TDM, the IoT device 804 may be allocated a transmission time interval (TTI) to send the response (MSG1). For FDM, the IoT device 804 may be allocated a frequency shift to modulate a received excitation signal (such as an energy excitation signal sent via the CW2D link of FIGS. 7A, 7B, and/or 7C) (not shown in FIG. 8A) into a specific frequency subband. For CDM, the IoT device 804 may be allocated a sequence associated with a spread-spectrum code to modulate the received excitation signal. In certain aspects, the IoT device 804 may be assigned a TTI, a frequency, and/or a sequence to use for the response (MSG1). In certain aspects, the IoT device 804 may randomly select the TTI, frequency shift, and/or sequence among a pool of communication resources, for example, indicated by the query message (MSG0).

In certain aspects, as part of the MSG1, the IoT device 804 may send an ID to the reader 802. The ID may include an ID that is unique to the IoT device 804. The ID may be randomly generated (e.g., such as by the IoT device 804), may be generated based on a configured ID for the IoT device 804, or may be generated in another way. In certain aspects, the response may be referred to as a “first random access message (MSG1)” for the inventory procedure 800A.

At 810, the reader 802 may respond with, and the IoT device 804 may receive, a D2R grant, or MSG2 (e.g., ambient IoT MSG2). For example, the reader 802 may allocate communication resources (e.g., one or more time resources and one or more frequency resources) for the IoT device 804 to reply with certain information, such as a device or asset identifier (e.g., an EPC ID), sensor measurement(s), and/or the like. The communication resources may be allocated for communications via the D2R link. In certain cases, the D2R grant may indicate a sequence associated with communication based at least in part on CDM, such as a sequence associated with a spread-spectrum code. In some aspects, the D2R grant may be referred to as a “second random access message (MSG2)” for the inventory procedure 800A.

In certain aspects, as part of the D2R grant (MSG2), the reader 802 may echo the ID received in the response (MSG1) from the IoT device 804. The IoT device 804 may consider a contention resolution as successful if the D2R grant (MSG2) includes the same random ID communicated in the response (MSG1). In certain aspects, a size of the random ID in the response (MSG1) may be sufficient for contention resolution purposes.

At 812, in response to the D2R grant (MSG2), the IoT device 804 sends certain device information, or MSG3 (e.g., ambient IoT MSG3) to the reader 802 via the D2R link. In certain aspects, the IoT device 804 may receive a second waveform (not shown in FIG. 8A) from reader 802, or another wireless device, which may activate IoT device (e.g., activate one or more RF chains or components of IoT device 804) to send a backscattered signal of the second waveform modulated with data, such as for example, the device information (MSG3) transmission.

In certain aspects, the IoT device 804 may send a device ID (e.g., configured or assigned ID for the IoT device 804) and/or any other upper layer data (e.g., depending on an upper layer request, such as information queried or triggered by the query message (MSG0)) in the device information (MSG3). For example, for the inventory procedure 800A, the device information (MSG3) may include inventory information (e.g., queried and/or triggered by the query message (MSG0)) for IoT device 804. In certain aspects, device information (MSG3) may be communicated in the time resource(s) and frequency resource(s) indicated in the D2R grant (MSG2). In certain aspects, the device information may be referred to as a “third random access message (MSG3)” for the inventory procedure 800A.

At 814, the reader 802 may send feedback, or MSG4 (e.g., ambient IoT MSG4) in response to receiving the device information (MSG3) from IoT device 804. The feedback (MSG4) may indicate whether the reader 802 successfully received and decoded the device information (MSG3) transmission. In certain aspects, the feedback (MSG4) may include an acknowledgement (ACK) message indicating that the reader 802 successfully received and decoded the device information (MSG3) transmission. In certain aspects, the feedback may include a negative ACK (NACK) message indicating that the reader 802 did not successfully receive and/or decode the device information (MSG3) transmission. In certain aspects, an ACK message may indicate, to the IoT device 804, to refrain from responding to subsequent query messages for a certain time period. In certain aspects, the feedback (MSG4) may be referred to as a “fourth random access message (MSG4)” for the inventory procedure 800A.

In certain aspects, the MSG0, the MSG2, and the MSG4 may include R2D transmissions (e.g., transmissions sent from the reader 802 to the IoT device 804 and/or other IoT devices). The reader 802 may send the MSG0, the MSG2, and the MSG4 via a physical R2D channel (PRDCH). Additionally, the MSG1 and the MSG3 may include D2R transmissions (e.g., transmissions sent from the IoT device 804 to the reader 802). The IoT device 804 may send the MSG1 and the MSG3 via a physical D2R channel (PDRCH). In certain aspects, due to limited capabilities of the IoT device 804 (e.g., limited filtering or no filtering capability), the R2D transmissions (e.g., the MSG0, the MSG2, and the MSG4) may support time division multiple access (TDMA).

In some cases, to reduce the latency associated with the inventory procedure, a fewer setep inventory procedure may be used. As the name implies, the fewer step (e.g., such as two-step) inventory procedure may effectively consolidate the messages of the inventory procedure 800A depicted in FIG. 8A into fewer messages (e.g., such as consolidate from a four-step inventory procedure to a two-step inventory procedure).

FIG. 8B depicts a process flow diagram of another example inventory procedure 800B performed between the IoT device 804 and the reader 802. In certain aspects, inventory procedure 800B may be referred to as a “two-step inventory procedure 800B.”

The inventory procedure 800B may begin, at 850, with the reader 802 broadcasting, and the IoT device 804, receiving a query message (MSGA). In certain aspects, the query message (MSGA) may be referred to as a “trigger message (MSGA).” The query message (MSGA) may effectively combine MSG0 and MSG2 described above with respect to FIG. 8A. The query message (MSGA) may include a R2D transmission and/or a PRDCH, as described previously. In certain aspects, the query message (MSGA) may be referred to as a “first random access message (MSGA)” for a two-step inventory procedure 800B.

At 852, the IoT device 804 sends a response (e.g., a random access response) (MSGB) to the reader 802. In certain aspects, the response (MSGB) may effectively combine MSG1 and MSG3 described above with respect to FIG. 8A. The response (MSGB) may include a D2R transmission and/or a PDRCH, as described previously. In certain aspects, the response (MSGB) may be referred to as a “second random access message” for a two-step inventory procedure 800B.

At 854, the reader 802 may send feedback based on the response (MSGB), for example, as described above with respect to FIG. 8A.

The inventory procedure 800B may include a CBRA procedure or a contention-free random access (CFRA) procedure. For the CBRA procedure, the IoT device 804 may include the random ID as described previously (e.g., fixed to 16 bits for the inventory procedure 800B) in the response (MSGB) and/or may indicate the random ID in a previous random access message. If the IoT device 804 includes the random ID in a previous random access message, the reader 802 may echo the random ID in the query message (MSGA). Alternatively, for the CFRA procedure, the IoT device 804 may directly send the device ID and/or upper layer data in the response (MSGB) after being triggered by the query message (MSGA) (e.g., the IoT device 804 skips contention resolution from the response (MSG1) and the D2R grant (MSG2) of the inventory procedure 800A).

Note that the inventory procedures 800A, 800B depicted in FIGS. 8A and 8B respectively, are example procedures to facilitate an understanding of certain ambient IoT services communicated between an ambient IoT device and a reader, such as IoT device 804 and reader 802. In some other examples, additional and/or alternative signaling may be used for an inventory procedure.

In some cases, aspects of the present disclosure may be applied to other types of ambient IoT services, such as a communication of a command or configuration addressed to an ambient IoT device. For example, the inventory procedures depicted in FIGS. 8A and 8B may be performed between an intermediate node and the IoT device 804 based on the reader 802 triggering the intermediate node and the IoT device 804 to perform the inventory procedures. That is, the reader 802 may trigger the intermediate node and the IoT device 804 to perform the inventory procedures via the MSG0, and the intermediate node and the IoT device 804 may exchange the information from the MSG1, MSG2, and MSG3 with each other, where the intermediate node then sends obtained inventory information from the IoT device 804 to the reader 802 upon completion of the inventory procedures.

Though FIGS. 8A and 8B describe inventory procedures performed between reader 802 and a single IoT device, e.g., IoT device 804, in some other cases, reader 802 may trigger multiple IoT devices, including IoT device 804, to perform a random access procedure, such as to enable inventory procedure 800A or inventory 800 for the multiple IoT devices.

For example, to enable inventory procedure 800A of FIG. 8A for multiple IoT devices, including IoT device 804, reader 802 may send the query message (MSG0) to multiple IoT devices (e.g., the query message may be broadcasted to multiple IoT devices), where the query message (MSG0) triggers random access, or more specifically the inventory procedure 800A, for the multiple IoT devices. Subsequently, the multiple IoT devices, or a subset of the multiple IoT devices, may each send a respective response (MSG1) to the query message (MSG0). Each response (MSG1) may include an ID (e.g., a random ID) associated with the corresponding IoT device. Each IoT device may send their respective response (MSG1) via backscatter communication. In certain aspects, for the D2R grant (MSG2), reader 802 may send separate DSR grants (MSG2 transmissions) to respective IoT devices (e.g., a single DSR grant (MSG2) may correspond to a respective response (MSG1) received from one IoT device). Alternatively, for the D2R grant (MSG2), reader 802 may send a single D2R grant (MSG2) to multiple IoT devices (e.g., the single D2R grant (MSG2) may correspond to multiple responses (MSG1 transmissions) received from the multiple IoT devices). The separate D2R grants (MSG transmissions) or the single D2R grant (MSG2) may indicate time resources and frequency resources that the multiple IoT devices may use to send respective device information (MSG3) transmissions back to reader 802.

In certain aspects, device information (MSG3) transmissions from the multiple IoT devices may be communicated, to reader 802, based on FDM. For example, each IoT device, including IoT device 804, may be assigned a frequency shift. Each IoT device may use its assigned frequency shift to modify the frequency of a backscattered signal, such as a device information (MSG3) transmission, sent by the respective IoT device to reader 802. In certain aspects, the frequency-shifted backscattered communications, e.g., the frequency-shifted MSG3 transmissions, may help to reduce self-interference at reader 802 during inventory procedure 800A. For example, each IoT device may shift a frequency of a backscattered signal (e.g., a device information (MSG3) transmission) relative to a frequency of a received excitation signal (e.g., waveform), from reader 802, to reduce self-interference at reader 802 during inventory procedure 800A.

### Example Frequency-Shifted Backscatter Communication

In certain aspects, an IoT device may use square wave modulation to modulate a backscattered signal (e.g., such as a device information (MSG3) transmission from the IoT device during an inventory procedure, as shown in FIG. 8A) as a square wave, thereby causing its frequency to shift relative to an excitation signal (e.g., a waveform) received at the IoT device.

While square wave modulation provides an efficient way to encode and shift the frequency of backscattered signals from an IoT device, such as to help reduce self-interference at a reader in communication with the IoT device and improve communication between the reader the IoT device, square wave modulation may produce unwanted interference (e.g., between the IoT device and one or more of the other IoT devices) at odd harmonics of the square wave. More specifically, every other harmonic may be absent (e.g., missing) for a square wave generated by the IoT device due to the duty cycle of the square wave, where a duty cycle may refer to the percentage of the waveform that occurs above the zero axis. For example, the duty cycle of a square wave may be 50%, or ½. Because the duty cycle is ½, every second harmonic may not be present. The remaining odd harmonics may result in interference between IoT devices, however, thereby degrading communications quality and efficiency.

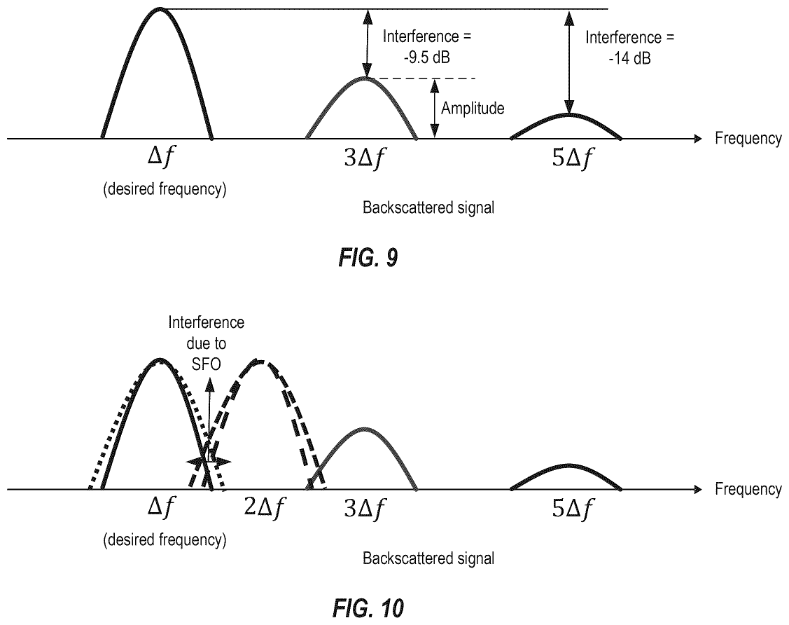

FIG. 9 depicts example harmonic composition of a square wave generated by an IoT device. The square wave may be generated with a fundamental frequency based on a frequency shift of Δf.

As shown in FIG. 9, the square wave may be composed of a fundamental frequency based on the Δf frequency shift and an infinite series of odd harmonics. Specifically, the harmonic composition for the square wave may include harmonics at frequencies based on 3Δf, 5Δf, 7Δf (not shown in FIG. 9), 9Δf (not shown in FIG. 9), and so on (also not shown in FIG. 9). Each subsequent harmonic, associated with 3Δf, 5Δf, 7Δf, 9Δf, etc. may have progressively decreasing amplitude, and thus may cause progressively less interference (e.g., the smaller the amplitude of a harmonic wave, the less impact it has on a signal, thereby leading to less interference with other signals and/or systems). For example, an amplitude of the harmonic associated with 5Δf may be less than an amplitude of the harmonic associated with 3Δf. Further, the interference resulting from the harmonic associated with 5Δf (e.g., interference=−14 decibels (dB)) may be less than the interference resulting from the harmonic associated with 3Δf (e.g., interference=−9.5 dB) (e.g., the interference level may reduce as the harmonics move away from the signal level at Δf).

In an illustrative example, a first IoT device may be assigned the Δf frequency shift, and use the assigned Δf frequency shift and square wave modulation to modulate a first backscattered signal (e.g., a first device information (MSG3) transmission) as the square wave (e.g., a first square wave) shown in FIG. 9. A second IoT device may be assigned the 2Δf frequency shift, and use the assigned 2Δf frequency shift and square wave modulation to modulate a second backscattered signal (e.g., a second device information (MSG3) transmission) as a second square wave. Further, a third IoT device may be assigned the 3Δf frequency shift, and use the assigned 3Δf frequency shift and square wave modulation to modulate a third backscattered signal (e.g., a third device information (MSG3) transmission) as a third square wave. In certain aspects, the harmonic of the first square wave generated by the first IoT device, and associated with 3Δf, may result in interference to the third IoT device (and its generated backscattered signal, also associated with frequency shift 3Δf) .

In addition to interference caused by odd harmonics of a backscattered signal, in certain aspects, interference at an IoT device may result due to a SFO between a reader and another IoT device. “SFO” between a reader and an IoT device may refer to a mismatch between the sampling frequencies of the reader and the IoT device, meaning a sampling clock used to sample data at the reader and a sampling clock used to sample data at the IoT device may be sampling data at different rates. IoT devices may be particularly susceptible to SFO due to their simple architectures and expectation of long periods of idleness. In certain aspects, due to the SFO between the reader and the IoT device, a backscattered signal from the IoT device may be leaked into neighboring frequencies, and thus may cause interference to at least another IoT device assigned to use one of the neighboring frequencies for backscatter communication.

For instance, in the previous illustrative example, the first backscattered signal generated as the first square wave by the first IoT device based on the assigned Δf frequency shift may interfere with the second backscattered signal generated as the second square wave by the second IoT device based on the assigned 2Δf frequency shift. That is, the first backscattered signal associated with the Δf frequency shift may spread, or appear, at a frequency associated with the 2Δf frequency shift (e.g., assigned to the second IoT device for backscatter communication). This spreading (or leakage) of the first backscattered signal may cause unwanted interference to the second IoT device (and its second backscattered signal). Such interference, based on the SFO between a reader and the first IoT device, is depicted in FIG. 10.

In certain aspects, a reader may reduce interference between IoT devices, which utilize square wave modulation for backscattering (e.g., such as during a random access procedure, or more specifically, an inventory procedure), based on assigning frequency shifts to the IoT devices that do not interfere with each other. That is, a reader may assign frequency shifts of {Δf, 4Δf, 8Δf, 16Δf . . . } to IoT devices such that interference from the odd harmonics of each respective frequency-shifted backscattered signal from each respective IoT device is reduced (or minimized). Further, the reader may assign frequency shifts {Δf, 4Δf, 8Δf, 16Δf . . . } to the IoT devices, without assigning frequency shift 2Δf, such as to avoid the interference between neighboring frequencies based on frequency shifts Δf and 2Δf, due to SFO. That is, for example, the IoT device may (1) indicate, to a first IoT device, to use frequency shift Δf for the transmission of backscattered signal(s) from the first IoT device, (2) indicate, to a second IoT device, to use frequency shift 4Δf for the transmission of backscattered signal(s) from the second IoT device, (3) indicate, to a third IoT device, to use frequency shift 8Δf for the transmission of backscattered signal(s) from the third IoT device, etc.

Each frequency shift {Δf, 4Δf, 8Δf, 16Δf . . . } supported by the reader for backscatter communication, and which may be assigned to an IoT device, may correspond to a frequency of a respective bandwidth (e.g., a respective range of frequencies that a signal may occupy). While the respective bandwidth associated with each frequency shift may be associated with different minimum and maximum frequencies, the frequency range of each respective bandwidth may be the same. Thus, different frequency shifts {Δf, 4Δf, 8Δf, 16Δf . . . } may be allocated to different IoT devices but with a same bandwidth, such that different frequency-shifted backscattered signals from different IoT device utilize/occupy a same frequency range width.

Allocating the same bandwidth to different IoT devices for backscattered communication of different frequency-shifted signals (e.g., such as during a random access procedure, or more specifically, an inventory procedure) may result in under-utilization of the available frequency spectrum. This spectrum usage may reduce the overall capacity of the wireless network and/or lower the spectral efficiency, which may negatively impact network performance and/or overall user experience.

### Aspects Related to Variable Bandwidth for FDMed Backscatter Communications

Aspects of the present disclosure improve upon the state of the art by providing techniques for allocating variable bandwidth to IoT devices (e.g., such as ambient IoT devices) for FDMed backscatter communications. More specifically, aspects described herein provide techniques for (1) determining different frequency shifts (e.g., among frequency shifts of {Δf, 4Δf, 8Δf, . . . }) and different bandwidth allocations that may be used by different IoT devices for the transmissions (e.g., simultaneous transmission) of backscattered signals over a communications channel, and (2) signaling the different frequency shifts and different bandwidth allocations to the IoT devices.

It some cases, FDMed backscatter communications may be utilized by multiple IoT devices to allow for the multiple IoT devices to send backscattered signals at the same time (e.g., send multiple MSG3 messages at the same time) (e.g., multiplex multiple devices at the same time). In some cases, FDMed backscatter communications may be utilized by an IoT device to reduce self-interference at a reader receiving a backscattered signal from the IoT device, such that the backscattered signal does not interfere with a transmission of the reader.

According to aspects described herein, a frequency shift indicated to an IoT device may be used by the IoT device to modulate a backscattered signal as a square wave with a frequency shift of Δf relative to a received waveform (e.g., an excitation signal). The IoT device may send the backscattered signal in a bandwidth allocation indicated to the IoT device. In certain aspects, the IoT device may use the indicated frequency shift and bandwidth allocation to modulate and send a backscattered signal during a random access procedure, such as a random access procedure used to enable an inventory procedure (e.g., such as inventory procedure 800A of FIG. 8A or inventory procedure 800B of FIG. 8B) for at least the IoT device.

In certain aspects, the different frequency shifts and different bandwidth allocations determined to be used by different IoT devices for backscatter communication may be determined such that interference at a reader and/or interference between IoT devices is reduced (or minimized), and frequency utilization among the IoT devices is improved (e.g., especially for IoT devices assigned higher frequency shifts).

### Example Signaling of Variable Bandwidth Allocations for FDMed Backscatter Communications

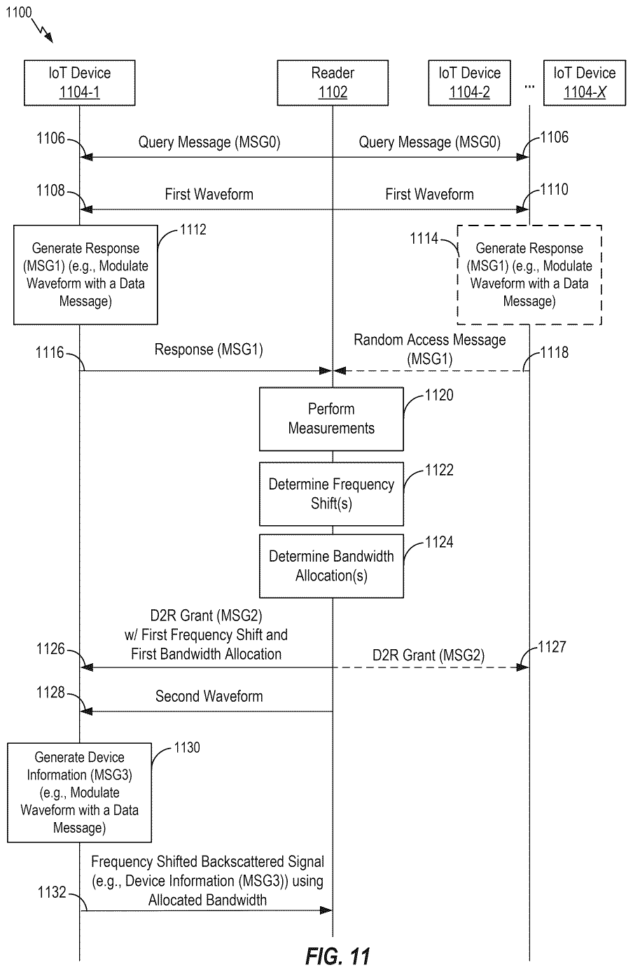

FIG. 11 depicts a process flow 1100 for communications in a network between a reader 1102 and multiple IoT devices 1104-1 through 1104-X, where X is an integer greater than one (collectively referred to herein as “IoT devices 1104” and individually referred to herein as “IoT device 1104”). In certain aspects, each IoT device 1104 may be an example of the UE 104 depicted and described with respect to FIG. 1 or the UE 304 depicted and described with respect to FIG. 3. In certain aspects, each IoT device 1104 may include any of the energy harvesting architectures described herein with respect to FIGS. 5 and 6. In certain aspects, one or more of the IoT devices 1104 may comprise an ambient IoT device. In certain aspects, the reader 1102 may be an example of the BS 102 depicted and described with respect to FIGS. 1 and 3 or a disaggregated base station depicted and described with respect to FIG. 2. In certain aspects, the reader 1102 may be an example of the UE 104 or the UE 304 depicted and described with respect to FIGS. 1 and 3.

In certain aspects, process flow 100 may be used for allocating variable bandwidth to IoT devices, such as IoT device 1104-1 shown in FIG. 11. In certain aspects, the allocated bandwidth may be used by IoT device 1104-1 for backscattering a frequency-shifted signal, such as during a random access procedure. In certain aspects, the random access procedure may be used to enable an inventory procedure between reader 1102 and one or more of the IoT devices 1104, such as IoT device 1104-1.

Note that any operations or signaling illustrated with dashed lines may indicate that that operation or signaling is an optional or alternative example.

Process flow 1100 begins, at 1106, with reader 1102 broadcasting, and the IoT devices 1104 receiving, a query message (MSG0). The query message (MSG0) may request a respective response from each IoT device 1104, and specifically a respective response, from each IoT device 1104, that includes certain information, such as a device or asset identifier, sensor measurement(s), and/or the like. The query message (MSG0) may indicate communication resources (e.g., time resources and frequency resources) for communication of a response from each IoT device 1104. In certain aspects, the query message (MSG0) may be considered to trigger the IoT devices 1104 to perform an inventory procedure.

The query message (MSG0) may be similar to the query message (MSG0) depicted and described with respect to the inventory procedure 800A of FIG. 8A and/or the query message (MSG0) depicted and described with respect to the inventory procedure 800B of FIG. 8B.

At 1116 and 1118, based on receiving the query message (MSG0), each IoT device 1104 may send a response (MSG1) to the reader 802 via backscattering. For example, at 1108, reader 1102 sends, to IoT device 1104-1 a first waveform (e.g., an excitation signal) at a first frequency. The first waveform may activate the IoT device 1104-1 (e.g., activate one or more RF chains or components of the IoT device 1104-1) to send a data message, such as the response (MSG1). That is, at 1112, IoT device 1104-1 modulates data on the received first waveform, such that it can be reflected to reader 1102 (e.g., via backscattering). Similarly, at 1110, reader 1102 sends, to one or more IoT devices 1104-2 through 1104-X, a first waveform (e.g., an excitation signal) at the first frequency. The first waveform may activate one or more of IoT devices 1104-1 through 1104-X (e.g., activate one or more RF chains or components of the one or more of IoT devices 1104-1 through 1104-X) to send a respective data message, such as a respective response (MSG1). That is, at 1114, one or more of the IoT devices 1104-2 through 1104-X may modulate respective data on the received first waveform, such that it can be reflected to reader 1102 (e.g., via backscattering) by each IoT device. In this example, at least one of the IoT devices 1104-2 through 1104-X, such as IoT device 1104-2 may generate a response (MSG1) and backscatter the response to reader 1102, at 1114 and 1118, respectively.

In certain aspects, each response (MSG1) may be sent to reader 1102, by the IoT devices 1104, via a physical random access channel (PRACH). In certain aspects, each response (MSG1) may be sent to reader 1102, by the IoT devices 1104, using one or more time resources and one or more frequency resource indicated in the query message (MSG0) transmitted to the IoT devices 1104 at 1106. In certain aspects, the response (MSG1) sent by each IoT device 1104, at 1116 and 1118, may be sent based on FDM. For example, each IoT device 1104 may utilize a frequency shift (e.g., a frequency shift allocated to each IoT device 1104) to modulate the received first waveform with a respective second frequency. The second frequency associated with a respective response (MSG1), generated by an IoT device 1104, may be different than the first frequency associated with the first waveform.

In certain aspects, the IoT device 1104-1 may send an ID as part of the response (MSG1) sent to reader 1102 at 1116. The ID may include an ID that identifies and/or is unique to IoT device 1104-1. The ID may be randomly generated (e.g., such as by the IoT device 1104-1), may be generated based on a configured ID for the IoT device 1104-1, or may be generated in another way. Similarly, each response (MSG1) sent, at 1118, to reader 1102 by one of IoT devices 1104-2 through 1104-X may include an ID associated with the IoT device sending the response.

The response (MSG1) from each IoT device 1104 may be similar to the response (MSG1) depicted and described with respect to the inventory procedure 800A of FIG. 8A.

At 1120, reader 1102 performs measurements associated with the received responses (MSG1 transmissions). For example, at 1120, reader 1102 may measure a first SNR associated with the response (MSG1) from IoT device 1104. Further, reader 1102 may measure a respective SNR associated with each response (MSG1) received from each IoT device among IoT devices 1104-2 through 1104-X. For example, in cases where IoT device 1104-2 (among IoT devices 1104-2 through 1104-X) sends a response (MSG1) to reader 1102, reader 1102 may measure, at 1120, a second SNR associated with the response (MSG1) received from IoT device 1104-2.

At 1122, reader 1102 determines one or more frequency shifts, which may be used by one or more of the IoT devices 1104 for backscattering a respective device information (MSG3) transmission. In this example, at 1122, reader 1102 determines at least a first frequency shift for a device information (MSG3) transmission from IoT device 1104-1. Put differently, at 1122, reader 1102 may determine a first frequency shift that is to be assigned to IoT device 1104-1 for backscattering the device information (MSG3) transmission.

In certain aspects, reader 1102 determines the first frequency shift to be assigned to IoT device 1104-1 based on the SNR associated with the response (MSG1) from IoT device 1104-1 and/or the respective SNR associated with each response (MSG1) from each IoT device 1104-2 through 1104-X.

For example, if the SNR associated with the response (MSG1) from IoT device 1104-1 is greater than the respective SNR measured for a threshold number of responses (MSG1 transmissions) from IoT devices 1104-2 through 1104-X, then a larger first frequency shift (e.g., such as frequency shift 8Δf or frequency shift 16Δf) may be assigned to IoT device 1104-1 than the respective frequency shift(s) assigned to one or more of the IoT devices 1104-2 through 1104-X. As another example, if the SNR associated with the response (MSG1) from IoT device 1104-1 is greater than the SNR measured for the response (MSG1) from IoT device 1104-2, then a larger first frequency shift (e.g., such as frequency shift 8Δf or frequency shift 16Δf) may be assigned to IoT device 1104-1 than a second frequency shift assigned to IoT device 1104-2. As another example, if the SNR associated with the response (MSG1) from IoT device 1104-1 is greater than a threshold SNR, then a larger first frequency shift (e.g., such as frequency shift 8Δf or frequency shift 16Δf) may be assigned to IoT device 1104-1.

Alternatively, if the SNR associated with the response (MSG1) from IoT device 1104-1 is less than the respective SNR measured for a threshold number of responses (MSG1 transmissions) from IoT devices 1104-2 through 1104-X, then a smaller first frequency shift (e.g., such as frequency shift Δf or frequency shift 4Δf) may be assigned to IoT device 1104-1 than the respective frequency shift(s) assigned to one or more of the IoT devices 1104-2 through 1104-X. As another example, if the SNR associated with the response (MSG1) from IoT device 1104-1 is less than the SNR measured for the response (MSG1) from IoT device 1104-2, then a smaller first frequency shift (e.g., such as frequency shift Δf or frequency shift 4Δf) may be assigned to IoT device 1104-1 than a second frequency shift assigned to IoT device 1104-2. As another example, if the SNR associated with the response (MSG1) from IoT device 1104-1 is less than a threshold SNR, then a smaller first frequency shift (e.g., such as frequency shift Δf or frequency shift 4Δf) may be assigned to IoT device 1104-1.

In certain aspects, reader 1102 determines the first frequency shift that is to be assigned to IoT device 1104-1 as a frequency shift that reduces (or minimizes) interference to IoT device 1104-1. For example, reader 1102 may determine that the IoT device 1104-1 is to (1) use a frequency shift that is not impacted by the odd harmonics of backscattered signal(s) from other IoT devices 1104, (2) use a frequency shift that is not impacted a first odd harmonic (e.g., such as 3Δf for a backscattered signal generated based on a frequency shift of Δf) of any other backscattered signal from other IoT devices 1104, (3) use a frequency shift that minimizes the interference caused by odd harmonics of backscattered signal(s) from other IoT devices 1104, and/or (4) use a frequency shift that results in a least amount of interference to the IoT device 1104-1, and its backscattered signal(s), which is caused by SFO.

For example, IoT device 1104-2 may be assigned a second frequency shift of Δf, and use this second frequency shift Δf to generate a square wave for backscattering data to reader 1102. Odd harmonics of the square wave, such as associated with 3Δf, 5Δf, and 7Δf, may cause unwanted interference to IoT device 1104-1, or more specifically a signal backscattered by IoT device 1104-1. The harmonic associated with 3Δf may cause a greater amount of interference than the harmonic associated with 7Δf. Thus, when determining the first frequency shift to be assigned to IoT device 1104-1 for backscatter communication, reader 1102 may assign, to IoT device 1104-1, the first frequency shift of 8Δf instead of 4Δf among frequency shifts {Δf, 4Δf, 8Δf, . . . }. Specifically, by assigning IoT device 1104-1 the frequency shift 8Δf, the interference (e.g., due to SFO) from odd harmonics of a backscattered signal (e.g., square wave) generated by IoT device 1104-2 may be reduced, and further interference caused by a first harmonic (e.g., associated with 3Δf) of a backscattered signal (e.g., square wave) generated by IoT device 1104-2 may be avoided.

At 1124, reader 1102 determines one or more bandwidth allocations, which may be used by one or more of the IoT devices 1104 for backscattering a respective device information (MSG3) transmission. In this example, at 1124, reader 1102 determines at least a first bandwidth allocation for a device information (MSG3) transmission from IoT device 1104-1. Put differently, at 1124, reader 1102 may determine a first bandwidth allocation that may be used for the transmission of the device information (MSG3) from IoT device 1104-1.

In certain aspects, reader 1102 determines the first bandwidth allocation to be used by IoT device 1104-1 based on the SNR associated with the response (MSG1) from IoT device 1104-1 and/or the respective SNR associated with each response (MSG1) from each IoT device 1104-2 through 1104-X.

For example, if the SNR associated with the response (MSG1) from IoT device 1104-1 is greater than the respective SNR measured for a threshold number of responses (MSG1 transmissions) from IoT devices 1104-2 through 1104-X, then a larger bandwidth (e.g., larger frequency range width) may be allocated to IoT device 1104-1 for backscatter communication (e.g., for backscattering a device information (MSG3) transmission) than the respective bandwidth(s) allocated to one or more of the IoT devices 1104-2 through 1104-X for backscatter communication. As another example, if the SNR associated with the response (MSG1) from IoT device 1104-1 is greater than the SNR measured for the response (MSG1) from IoT device 1104-2, then a larger bandwidth (e.g., larger frequency range width) may be allocated to IoT device 1104-1 than a bandwidth allocated to IoT device 1104-2. As another example, if the SNR associated with the response (MSG1) from IoT device 1104-1 is greater than a threshold SNR, then a larger bandwidth may allocated to IoT device 1104-1 for backscatter communication.

Alternatively, if the SNR associated with the response (MSG1) from IoT device 1104-1 is less than the respective SNR measured for a threshold number of responses (MSG1 transmissions) from IoT devices 1104-2 through 1104-X, then a smaller bandwidth (e.g., smaller frequency range width) may be allocated to IoT device 1104-1 for backscatter communication (e.g., for backscattering a device information (MSG3) transmission) than the respective bandwidth(s) allocated to one or more of the IoT devices 1104-2 through 1104-X for backscatter communication. As another example, if the SNR associated with the response (MSG1) from IoT device 1104-1 is less than the SNR measured for the response (MSG1) from IoT device 1104-2, then a smaller bandwidth (e.g., larger frequency range width) may be allocated to IoT device 1104-1 than a bandwidth allocated to IoT device 1104-2. As another example, if the SNR associated with the response (MSG1) from IoT device 1104-1 is less than a threshold SNR, then a smaller bandwidth may allocated to IoT device 1104-1 for backscatter communication.

In certain aspects, reader 1102 determines the first frequency bandwidth allocation, which may be used by IoT device 1104-1 for backscattering a device information (MSG3) transmission to reader 1102, based on the frequency shift determined to be assigned to IoT device 1104-1 (e.g., determined at 1122). For example, a larger bandwidth (e.g., larger frequency range width) may be allocated to IoT device 1104-1 when the IoT device 1104-1 is assigned a high frequency shift (e.g., such as frequency shift 8Δf or frequency shift 16Δf). Similarly, a smaller bandwidth (e.g., smaller frequency range width) may be allocated to IoT device 1104-1 when the IoT device 1104-1 is assigned a low frequency shift (e.g., such as frequency shift Δf or frequency shift 4Δf).

In certain aspects, reader 1102 determines the first frequency bandwidth allocation, which may be used by IoT device 1104-1 for backscattering a device information (MSG3) transmission to reader 1102, as a bandwidth that reduces the SFO impact on IoT device 1104-1. For example, due to SFO, actual bandwidth that is received at reader 1102 may be higher. For example, in cases where reader 1102 allocates a bandwidth of B, then the actual received bandwidth may be [B +(B*max SFO)]. With 105 ppm SFO, the actual received bandwidth may be equal to (1.1*B). Thus, the allocated bandwidth may be lower, such as to help avoid the actual bandwidth of multiple devices from overlapping.

In certain aspects, at 1124, reader 1102 determines, based on an implementation of reader 1102, one or more bandwidth allocations. The one or more bandwidth allocations may be used by one or more of the IoT devices 1104 for backscattering a respective device information (MSG3) transmission.

At 1126 in process flow 1100, the reader 1102 responds to the response (MSG1) from IoT device 1104-1 with a D2R grant (MSG2). In certain aspects, the D2R grant (MSG2) may indicate the first frequency shift assigned to IoT device 1104-1 for backscattering a device information (MSG3) transmission to reader 1102 (e.g., determined at 1122 by reader 1102). In certain aspects, the D2R grant (MSG2) may indicate the first bandwidth allocation for the transmission of the device information (MSG3) to reader 1102 (e.g., determined at 1124 by reader 1102). The transmission of the device information (MSG3) transmission to reader 1102, from IoT device 1104-1, may be via a D2R link between IoT device 1104-1 and reader 1102.

In certain aspects, as part of the D2R grant (MSG2) to IoT device 1104-1, the reader 1102 may echo the ID received in the response (MSG1) from the IoT device 1104-1. The IoT device 1104-1 may consider a contention resolution as successful if the D2R grant (MSG2) includes the same ID communicated in the response (MSG1) from IoT device 1104-1 to reader 1102 at 1116. In certain aspects, the ID comprises a tag ID associated with IoT device 1104-1.

In certain aspects, the D2R grant (MSG2) sent from reader 1102, to IoT device 1104-1, may further include a time domain resource allocation for the transmission of the device information (MSG3) from IoT device 1104-1. In certain aspects, the D2R grant (MSG2) sent from reader 1102, to IoT device 1104-1, may further include a coding rate for the transmission of the device information (MSG3) from IoT device 1104-1.

In some cases, at 1127 in process flow 1100, the reader 1102 may respond to the response (MSG1) from at least one IoT device, among IoT devices 1104-2 through 1104-X, with a D2R grant (MSG2). In certain aspects, the D2R grant (MSG2), sent to the at least one IoT device among IoT devices 1104-2 through 1104-X, may indicate the frequency shift assigned to the specific IoT device for backscattering a device information (MSG3) transmission to reader 1102 (e.g., which may have been determined at 1122 by reader 1102). In certain aspects, the D2R grant (MSG2), sent to the at least one IoT device among IoT devices 1104-2 through 1104-X, may indicate the bandwidth allocated for the transmission of the device information (MSG3) to reader 1102 from the specific IoT device. In some cases, the transmission at 1127 in process flow 110 may include a D2R grant (MSG2) to each IoT device of multiple IoT devices among IoT devices 1104-2 through 1104-X.

The D2R grant (MSG2) from reader 1102 to IoT device 1104-1 (and/or each D2R grant (MSG2) from reader 1102 to IoT device(s) 1104-2 through 1104-X) may be similar to the D2R grant (MSG2) depicted and described with respect to the inventory procedure 800A of FIG. 8A.

At 1128, reader 1102 sends, to IoT device 1104-1 a second waveform (e.g., an excitation signal) at a third frequency. The second waveform may activate the IoT device 1104-1 (e.g., activate one or more RF chains or components of the IoT device 1104-1) for sending a data message, such as the device information (MSG3) transmission. That is, at 1130, IoT device 1104-1 modulates data on the received second waveform, such that it can be reflected to reader 1102 (e.g., via backscattering). In certain aspects, IoT device 1104-1 may utilize the first frequency shift assigned to IoT device 1104-1 (e.g., and indicated to IoT device 1104-1 at 1126) to modulate the received second waveform with a fourth frequency. The fourth frequency associated with the device information (MSG3) transmission, generated by IoT device 1104-1, may be different than the third frequency associated with the second waveform.

At 1132, IoT device 1104-1 sends the device information (MSG3) to reader 1102 in the first bandwidth allocation, which was indicated to IoT device 1104-1, by reader 1102, at 1126. The device information (MSG3) transmission may be a frequency-shifted transmission that has been shifted in frequency by the first frequency shift assigned to IoT device 1104-1.

Although in this example only IoT device 1104-1 is shown to receive an indication of a frequency shift and allocated bandwidth, and thus use the indicated frequency shift and the allocated bandwidth for the transmission of device information (MSG3) from IoT device 1104-1, in some other examples, reader 1002 may indicate, to multiple IoT devices 1104, different frequency shifts and different bandwidths allocated for backscatter communication at the multiple IoT devices 1104, which may be used by the multiple IoT devices 1104 for backscattering device information (MSG3) transmissions.

Note that the process flow 1100 illustrated in FIG. 11 is described herein to facilitate an understanding of variable bandwidth allocation for backscatter communication, and aspects of the present disclosure may be performed in various manners via alternative or additional signaling and/or operations. In certain aspects, the operations and/or signaling of FIG. 11 may occur in an order different from that described or depicted, and various actions, operations, and/or signaling may be added, omitted, or combined.

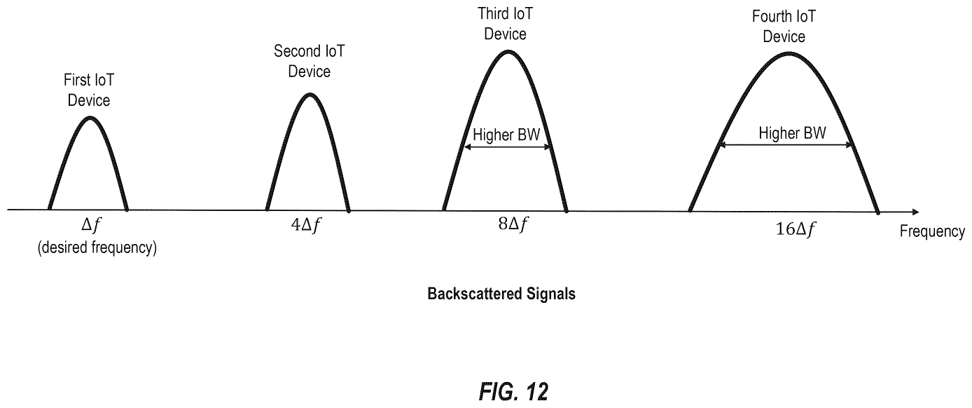

FIG. 12 depicts example frequency shifts and bandwidths, which may be allocated to different IoT devices for backscatter communications. The frequency shifts and bandwidths allocated to the different IoT devices may be determined by a reader in communication with the IoT devices (e.g., such as determined by reader 1102 at 1122 and 1124 in FIG. 11).

As shown in FIG. 12, the reader may assign a frequency shift Δf to a first IoT device, assign a frequency shift 4Δf to a second IoT device, assign a frequency shift 8Δf to a third IoT device, and assign a frequency shift 16Δf to a fourth IoT device. In certain aspects, an SNR associated with fourth IoT device may be greater than an SNR associated with the third IoT device, an SNR associated with the second IoT device, and an SNR associated with the first IoT device, such that a higher (or highest) frequency shift (e.g., frequency shift 16Δf among frequency shifts {Δf, 4Δf, 8Δf, 16Δf} ) is assigned to the fourth IoT device. In certain aspects, the SNR associated with first IoT device may be less than the SNR associated with the second IoT device, the SNR associated with the third IoT device, and the SNR associated with the fourth IoT device, such that a lower (or lowest) frequency shift (e.g., frequency shift Δf among frequency shifts {Δf, 4Δf, 8Δf, 16Δf} ) is assigned to the first IoT device.

Further, as shown in FIG. 12, the reader may allocate variable bandwidth to the IoT devices for backscatter communication. For example, bandwidth allocated to the third IoT device for backscatter communication may be greater than the respective bandwidth allocated to the first IoT device and the second IoT device for respective backscatter communication. Further, bandwidth allocated to the fourth IoT device for backscatter communication may be greater than the respective bandwidth allocated to the first IoT device, the second IoT device, and the third IoT device for respective backscatter communication. In certain aspects, the least bandwidth (e.g., a smallest frequency range width) may be allocated to the first IoT device based on the first IoT device being allocated the lowest frequency shift. Similarly, in certain aspects, the greatest bandwidth (e.g., a largest frequency range width) may be allocated to the fourth IoT device based on the fourth IoT device being allocated the highest frequency shift. In certain aspects, the bandwidth allocated to each IoT device may be based on the SNR associated with each IoT device. In certain aspects, the bandwidth allocated to each IoT device may be determined to reduce interference between the IoT devices. In certain aspects, the bandwidth allocated to each IoT device may be based on an implementation of the reader.

FIG. 13 depicts example bandwidth allocation, for backscatter communication at four IoT devices, based on frequency shifts assigned to the four IoT devices. As shown in FIG. 13, a reader (e.g., such as reader 1102 in FIG. 11) may assign a frequency shift Δf to a first IoT device, assign a frequency shift 4Δf to a second IoT device, assign a frequency shift 8Δf to a third IoT device, and assign a frequency shift 16Δf to a fourth IoT device. Further, the reader may allocate a bandwidth of Δf to both the first IoT device and the second IoT device, as well as allocate a respective bandwidth of Δf, 2Δf, or 4Δf to each of the third IoT device and the fourth IoT device.

Specifically, a first harmonic of a backscatter signal associated with frequency shift Δf (e.g., generated by the first IoT device) may occur at 3Δf, and a first harmonic of a backscatter signal associated with frequency shift 4Δf (e.g., generated by the second IoT device) may occur at 12Δf (e.g., 4×3Δf=12Δf). Thus, a bandwidth of Δf, 2Δf, or 4Δf may be allocated to the third IoT device and/or the fourth IoT device.

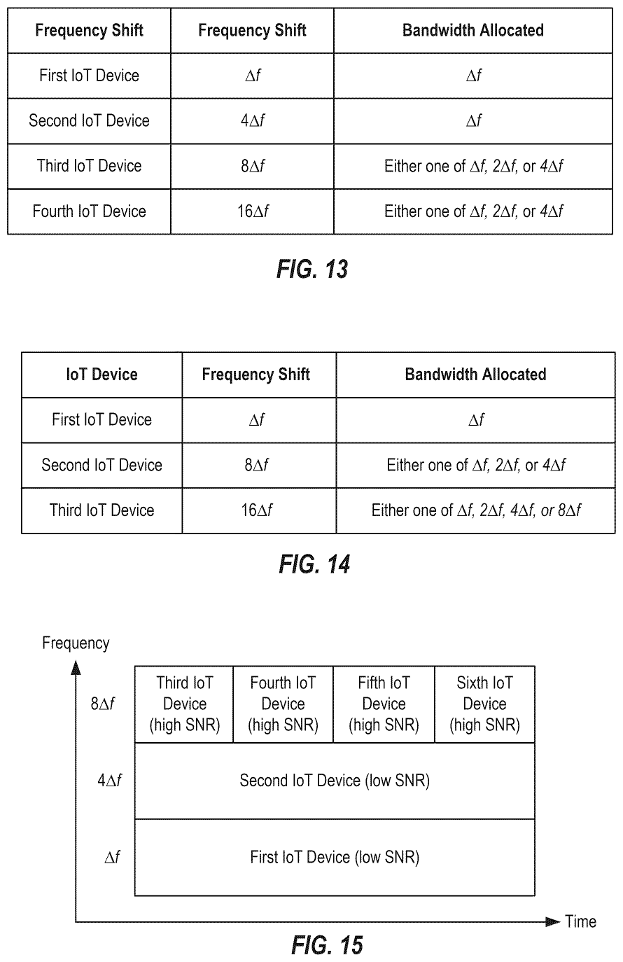

FIG. 14 depicts example bandwidth allocation, for backscatter communication at three IoT devices, based on frequency shifts assigned to the three IoT devices. As shown in FIG. 14, a reader (e.g., such as reader 1102 in FIG. 11) may assign a frequency shift Δf to a first IoT device, assign a frequency shift 8Δf to a second IoT device, and assign a frequency shift 16Δf to a third IoT device. Further, the reader may allocate a bandwidth of Δf to the first IoT device, allocate a bandwidth of Δf, 2Δf, or 4Δf to the second IoT device, and allocate a bandwidth of Δf, 2Δf, 4Δf, or 8Δf to the third IoT device.

Specifically, given a frequency shift of 4Δf is not assigned to any of the IoT devices (e.g., is not scheduled, unlike in FIG. 13), no harmonic may be produced at 12Δf ; thus, a bandwidth of 8Δf may be allocated to the fourth IoT device (e.g., assigned the 16Δf frequency shift). For example, if a bandwidth of 8Δf is allocated to a 16Δf frequency shift, then a signal may occupy bandwidth from 12Δf to 20Δf (e.g., where 16Δf is the central frequency). If there is a harmonic at 12Δf, then the signal may experience interference.

In certain aspects, allocating variable bandwidth to IoT devices, such as higher bandwidth for some IoT device backscatter communications, may help to schedule a higher number of IoT devices for a given amount of resources. For example, by allowing for the allocation of a 4Δf bandwidth, four times the number of IoT devices may be scheduled in the same time duration of the Δf bandwidth. This scenario is illustrated in FIG. 15 where backscatter communications of four devices, e.g., third, fourth, fifth, and sixth IoT devices, are scheduled in a same Δf bandwidth for a same time duration as a backscatter communication of a first IoT device and/or backscatter communication of a second IoT device allocated a smaller amount of bandwidth.

In certain aspects, higher bandwidth allocation for one or more IoT devices may be used for one or more other cases. For example, in applications where a reader knows the SNR of a device (e.g., such as in sensor applications), the reader may allocate a higher bandwidth to a device that has high SNR and/or requires to transmit a higher amount of data.

### Example Operations of a Reader

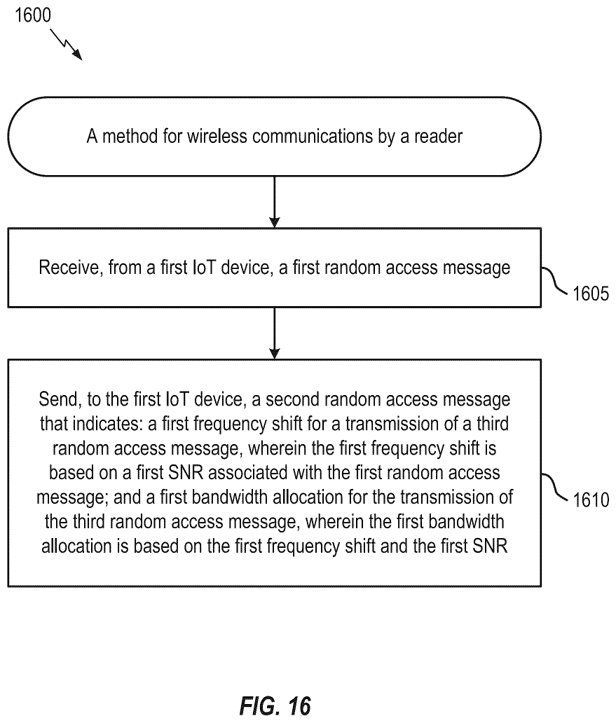

FIG. 16 shows a method 1600 for wireless communications by a reader, such as UE 104 of FIG. 1, UE 304 of FIG. 3, BS 102 of FIG. 1, a first network entity 300 or second network entity 302 of FIG. 3, and/or a disaggregated base station as discussed with respect to FIG. 2.

Method 1600 begins at block 1605 with receiving, from a first IoT device, a first random access message. Example receiving of a first random access message is depicted and described above with respect to steps 1116 and 1118 of FIG. 11.

Method 1600 then proceeds to block 1610 with sending, to the first IoT device, a second random access message that indicates: a first frequency shift for a transmission of a third random access message, wherein the first frequency shift is based on a first SNR associated with the first random access message; and a first bandwidth allocation for the transmission of the third random access message, wherein the first bandwidth allocation is based on the first frequency shift and the first SNR. Example sending of a second random access message that indicates a frequency shift and a bandwidth allocation is depicted and described above with respect to step 1126 of FIG. 11.

In some aspects, block 1605 includes receiving a plurality of first random access messages from a plurality of IoT devices, the plurality of first random access messages from the plurality of IoT devices comprising at least the first random access message from the first IoT device and another first random access message from a second IoT device; the first bandwidth allocation is based on a respective SNR associated with each of the plurality of first random access messages, which includes at least: the first SNR associated with the first random access message from the first IoT device; and a second SNR associated with the other first random access message from the second IoT device.

In some aspects, the first SNR is less than the second SNR; and the first frequency shift, for the transmission of the third random access message, is less than a second frequency shift for a transmission of another third random access message associated with the second IoT device.

In some aspects, the first bandwidth allocation, for the transmission of the third random access message, is smaller than a second bandwidth allocation for the transmission of the other third random access message associated with the second IoT device.

In some aspects, the first SNR is greater than the second SNR; and the first frequency shift, for the transmission of the third random access message, is greater than a second frequency shift for a transmission of another third random access message associated with the second IoT device.

In some aspects, the first bandwidth allocation, for the transmission of the third random access message, is greater than a second bandwidth allocation for the transmission of the other third random access message associated with the second IoT device.

In some aspects, method 1600 further includes, for each candidate frequency shift of a plurality of candidate frequency shifts for the transmission of the third random access message, and for each candidate bandwidth allocation of a plurality of candidate bandwidth allocations for the transmission of the third random access message: determining a respective interference to the first IoT device caused by one or more of the plurality of IoT devices.

In some aspects, method 1600 further includes determining the first frequency shift, among the plurality of candidate frequency shifts, and the first bandwidth allocation, among the plurality of candidate bandwidth allocations, for the transmission of the third random access message based on the respective interference associated with the first frequency shift and the first bandwidth allocation.

In some aspects, a first harmonic associated with a transmission of another third random access message associated with the second IoT device does not interfere with the transmission of the third random access message based on the first frequency shift and the first bandwidth allocation.

In some aspects, method 1600 further includes determining a SFO associated with at least another transmission of another third random access message that is associated with the second IoT device and that is based on a second frequency shift, wherein at least one of the first frequency shift or the first bandwidth allocation is further based on the SFO.

In some aspects, the second random access message further indicates at least one of: a coding rate for the transmission of the third random access message; a time domain resource allocation for the transmission of the third random access message; or an ID associated with the first IoT device.

In some aspects, method 1600 further includes receiving, from the first IoT device, the third random access message based on the first frequency shift and in the first bandwidth allocation.

In some aspects, the first random access message comprises a random access response; the second random access message comprises a grant of time and frequency resources for the transmission of the third random access message; and the third random access message comprises device information for the first IoT device.

In some aspects, method 1600 further includes measuring the first SNR associated with the first random access message.

In some aspects, method 1600 further includes sending, to the first IoT device, a waveform to activate the first IoT device to transmit the third random access message via backscattering.

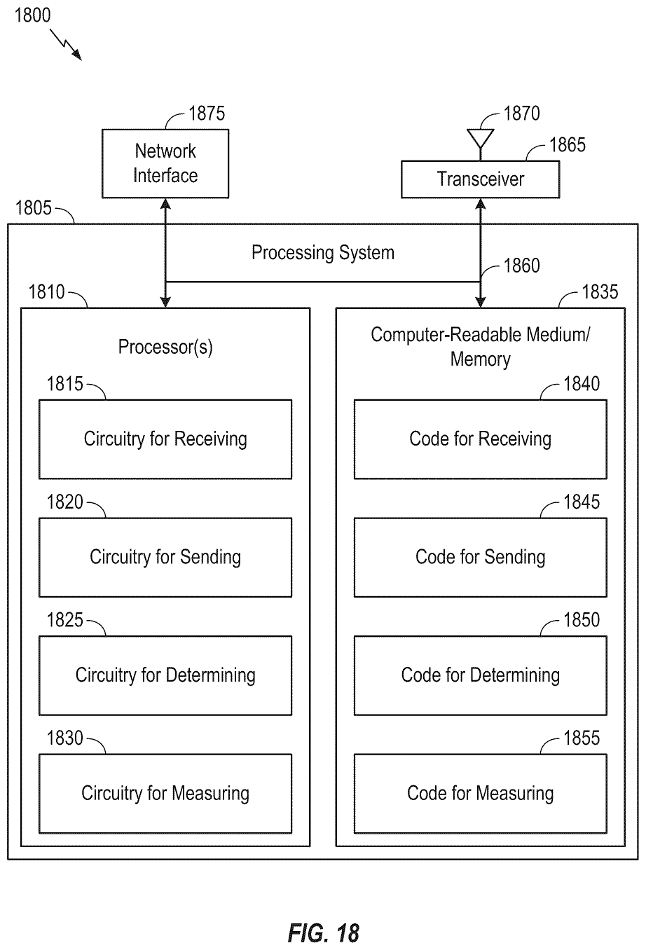

In some aspects, method 1600, or any aspect related to it, may be performed by an apparatus, such as communications device 1800 of FIG. 18, which includes various components operable, configured, or adapted to perform the method 1600. Communications device 1800 is described below in further detail.

Note that FIG. 16 is just one example of a method, and other methods including fewer, additional, or alternative operations are possible consistent with this disclosure.

### Example Operations of an IoT Device

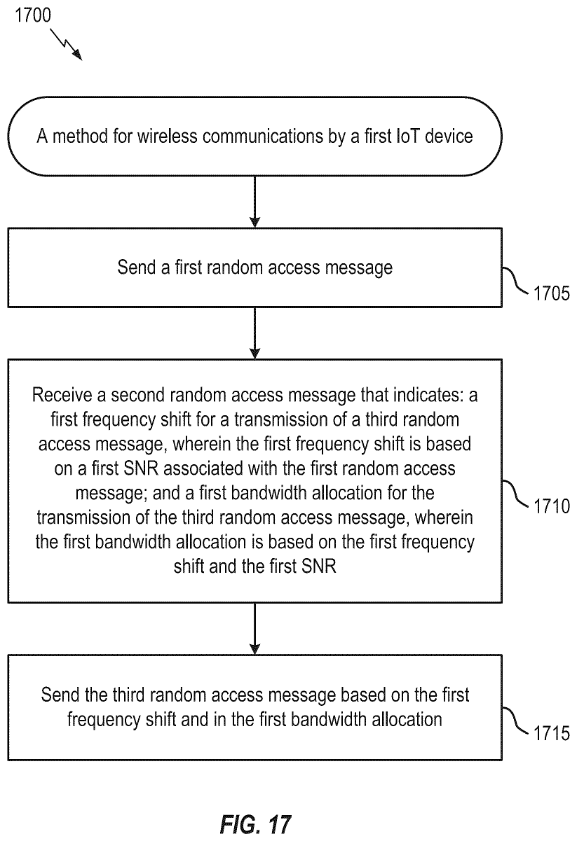

FIG. 17 shows a method 1700 for wireless communications by a first IoT device, such as UE 104 of FIG. 1 or UE 304 of FIG. 3.

Method 1700 begins at block 1705 with sending a first random access message. Example sending of a first random access message is depicted and described above with respect to steps 1116 and 1118 of FIG. 11.

Method 1700 then proceeds to block 1710 with receiving a second random access message that indicates: a first frequency shift for a transmission of a third random access message, wherein the first frequency shift is based on a first SNR associated with the first random access message; and a first bandwidth allocation for the transmission of the third random access message, wherein the first bandwidth allocation is based on the first frequency shift and the first SNR. Example receiving of a second random access message that indicates a frequency shift and a bandwidth allocation is depicted and described above with respect to step 1126 of FIG. 11.

Method 1700 then proceeds to block 1715 with sending the third random access message based on the first frequency shift and in the first bandwidth allocation. Example sending of a third random access message based on an indicated frequency shift and in an allocated bandwidth is depicted and described above with respect to step 1132 of FIG. 11.

In some aspects, the first bandwidth allocation is based on a respective SNR associated with each first random access message of a plurality of first random access messages associated with a plurality of IoT devices, which includes at least: the first SNR associated with the first random access message; and a second SNR associated with another first random access message from a second IoT device.

In some aspects, the first SNR is less than the second SNR; and the first frequency shift, for the transmission of the third random access message, is less than a second frequency shift for a transmission of another third random access message associated with the second IoT device.

In some aspects, the first bandwidth allocation, for the transmission of the third random access message, is smaller than a second bandwidth allocation for the transmission of the other third random access message associated with the second IoT device.

In some aspects, the first SNR is greater than the second SNR; and the first frequency shift, for the transmission of the third random access message, is greater than a second frequency shift for a transmission of another third random access message associated with the second IoT device.

In some aspects, the first bandwidth allocation, for the transmission of the third random access message, is greater than a second bandwidth allocation for the transmission of the other third random access message associated with the second IoT device.

In some aspects, a first harmonic associated with a transmission of another third random access message associated with the second IoT device does not interfere with the transmission of the third random access message based on the first frequency shift and in the first bandwidth allocation.

In some aspects, at least one of the first frequency shift or the first bandwidth allocation is further based on a SFO associated with at least another transmission of another third random access message that is associated with the second IoT device and that is based on a second frequency shift.

In some aspects, the second random access message further indicates at least one of: a coding rate for the transmission of the third random access message; a time domain resource allocation for the transmission of the third random access message; or an ID associated with the first IoT device.

In some aspects, the first random access message comprises a random access response; the second random access message comprises a grant of time and frequency resources for the transmission of the third random access message; and the third random access message comprises device information for the first IoT device.

In some aspects, method 1700 further includes receiving a waveform that activates the first IoT device to transmit the third random access message via backscattering, wherein block 1715 includes sending the third random access message via the backscattering based on the waveform.

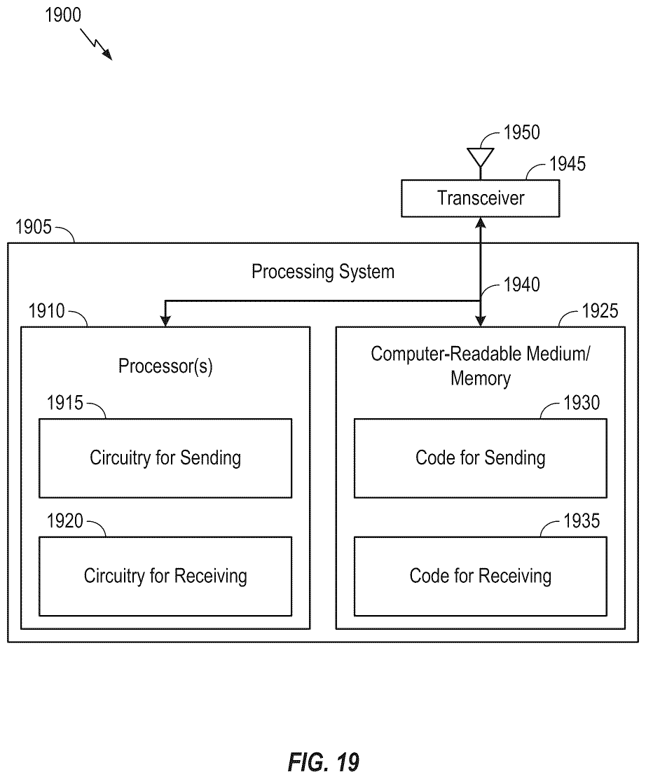

In some aspects, method 1700, or any aspect related to it, may be performed by an apparatus, such as communications device 1900 of FIG. 19, which includes various components operable, configured, or adapted to perform the method 1700. Communications device 1900 is described below in further detail.

Note that FIG. 17 is just one example of a method, and other methods including fewer, additional, or alternative operations are possible consistent with this disclosure.

### Example Communications Devices

FIG. 18 depicts aspects of an example communications device 1800 configured for wireless communications. In some aspects, communications device 1800 is a user equipment, such as UE 104 described above with respect to FIG. 1 or UE 304 described with respect to FIG. 3. In some aspects, communications device 1800 is a network entity, such as BS 102 of FIG. 1, first network entity 300 or second network entity of FIG. 3, or a disaggregated base station as discussed with respect to FIG. 2.

The communications device 1800 includes a processing system 1805 coupled to a transceiver 1865 (e.g., a transmitter and/or a receiver) and/or a network interface 1875. The transceiver 1865 is configured to transmit and receive signals for the communications device 1800 via an antenna 1870, such as the various signals as described herein. The network interface 1875 is configured to obtain and send signals for the communications device 1800 via communications link(s), such as a backhaul link, midhaul link, and/or fronthaul link as described herein, such as with respect to FIG. 2. The processing system 1805 may be configured to perform processing functions for the communications device 1800, including processing signals received and/or to be transmitted by the communications device 1800.

The processing system 1805 includes one or more processors 1810 and a computer-readable medium/memory 1835. In various aspects, the one or more processors 1810 may be representative of the one or more processors 318 described with respect to FIG. 3. The one or more processors 1810 are coupled to a computer-readable medium/memory 1835 via a bus 1860. In some aspects, the computer-readable medium/memory 1835 may be representative of the one or more memories 320 described with respect to FIG. 3. The computer-readable medium/memory 1835 is a non-transitory computer-readable medium/memory. In certain aspects, the computer-readable medium/memory 1835 is configured to store instructions (e.g., computer-executable code), that when executed by the one or more processors 1810, cause the one or more processors 1810 to perform the method 1600 described with respect to FIG. 16, or any aspect related to it, including any operations described in relation to FIG. 16. Note that reference to a processor performing a function of communications device 1800 may include one or more processors performing that function of communications device 1800, such as in a distributed fashion.

In the depicted example, computer-readable medium/memory 1835 stores code (e.g., executable instructions), including code for receiving 1840, code for sending 1845, code for determining 1850, and code for measuring 1855. Processing of the code 1840-1855 may enable and cause the communications device 1800 to perform the method 1600 described with respect to FIG. 16, or any aspect related to it. For example, in some aspects, code for receiving 1840 includes code for receiving, from a first IoT device, a first random access message. In some aspects, code for sending 1845 includes code for sending, to the first IoT device, a second random access message that indicates: a first frequency shift for a transmission of a third random access message, wherein the first frequency shift is based on a first SNR associated with the first random access message; and a first bandwidth allocation for the transmission of the third random access message, wherein the first bandwidth allocation is based on the first frequency shift and the first SNR.

The one or more processors 1810 include circuitry configured to implement (e.g., execute) the code stored in the computer-readable medium/memory 1835, including circuitry for receiving 1815, circuitry for sending 1820, circuitry for determining 1825, and circuitry for measuring 1830. Processing with circuitry 1815-1830 may enable and cause the communications device 1800 to perform the method 1600 described with respect to FIG. 16, or any aspect related to it. For example, in some aspects, circuitry for receiving 1815 includes circuitry for receiving, from a first IoT device, a first random access message. In some aspects, circuitry for sending 1820 includes circuitry for sending, to the first IoT device, a second random access message that indicates: a first frequency shift for a transmission of a third random access message, wherein the first frequency shift is based on a first SNR associated with the first random access message; and a first bandwidth allocation for the transmission of the third random access message, wherein the first bandwidth allocation is based on the first frequency shift and the first SNR.

More generally, means for communicating, transmitting, sending or outputting for transmission may include the one or more transceivers 324, one or more antennas 322, and/or processing system 316 of the UE 304 illustrated in FIG. 3, transceiver 1865, and/or antenna 1870, of the communications device 1800 in FIG. 18; and/or one or more processors 1810 of the communications device 1800 in FIG. 18. Means for communicating, receiving or obtaining may include the one or more transceivers 324, one or more antennas 322, and/or processing system 316 of the UE 304 illustrated in FIG. 3, transceiver 1865, and/or antenna 1870, of the communications device 1800 in FIG. 18; and/or one or more processors 1810 of the communications device 1800 in FIG. 18.
FIG. 19 depicts aspects of an example communications device 1900 configured for wireless communications. In some aspects, communications device 1900 is a user equipment, such as UE 104 described above with respect to FIG. 1 or UE 304 described with respect to FIG. 3. In some aspects, communications device 1900 is a tag, sensor, actuator, and/or wearable device.

The communications device 1900 includes a processing system 1905 coupled to a transceiver 1945 (e.g., a transmitter and/or a receiver). The transceiver 1945 is configured to transmit and receive signals for the communications device 1900 via an antenna 1950, such as the various signals as described herein. The processing system 1905 may be configured to perform processing functions for the communications device 1900, including processing signals received and/or to be transmitted by the communications device 1900.

The processing system 1905 includes one or more processors 1910 and a computer-readable medium/memory 1925. In various aspects, the one or more processors 1910 may be representative of the one or more processors 318 described with respect to FIG. 3. The one or more processors 1910 are coupled to a computer-readable medium/memory 1925 via a bus 1940. In some aspects, the computer-readable medium/memory 1925 may be representative of the one or more memories 320 described with respect to FIG. 3. The computer-readable medium/memory 1925 is a non-transitory computer-readable medium/memory. In certain aspects, the computer-readable medium/memory 1925 is configured to store instructions (e.g., computer-executable code), that when executed by the one or more processors 1910, cause the one or more processors 1910 to perform the method 1700 described with respect to FIG. 17, or any aspect related to it, including any operations described in relation to FIG. 17. Note that reference to a processor performing a function of communications device 1900 may include one or more processors performing that function of communications device 1900, such as in a distributed fashion.

In the depicted example, computer-readable medium/memory 1925 stores code (e.g., executable instructions), including code for sending 1930 and code for receiving 1935. Processing of the code 1930 and 1935 may enable and cause the communications device 1900 to perform the method 1700 described with respect to FIG. 17, or any aspect related to it. For example, in some aspects, code for sending 1930 includes code for sending a first random access message. In some aspects, code for receiving 1935 includes code for receiving a second random access message that indicates: a first frequency shift for a transmission of a third random access message, wherein the first frequency shift is based on a first SNR associated with the first random access message; and a first bandwidth allocation for the transmission of the third random access message, wherein the first bandwidth allocation is based on the first frequency shift and the first SNR. In some aspects, code for sending 1930 includes code for sending the third random access message based on the first frequency shift and in the first bandwidth allocation.

The one or more processors 1910 include circuitry configured to implement (e.g., execute) the code stored in the computer-readable medium/memory 1925, including circuitry for sending 1915 and circuitry for receiving 1920. Processing with circuitry 1915 and 1920 may enable and cause the communications device 1900 to perform the method 1700 described with respect to FIG. 17, or any aspect related to it. For example, in some aspects, circuitry for sending 1915 includes circuitry for sending a first random access message. In some aspects, circuitry for receiving 1920 includes circuitry for receiving a second random access message that indicates: a first frequency shift for a transmission of a third random access message, wherein the first frequency shift is based on a first SNR associated with the first random access message; and a first bandwidth allocation for the transmission of the third random access message, wherein the first bandwidth allocation is based on the first frequency shift and the first SNR. In some aspects, circuitry for sending 1915 includes circuitry for sending the third random access message based on the first frequency shift and in the first bandwidth allocation.

More generally, means for communicating, transmitting, sending or outputting for transmission may include the one or more transceivers 324, one or more antenna 322 and/or processing system 316 of the UE 304 illustrated in FIG. 3, transceiver 1945 and/or antenna 1950 of the communications device 1900 in FIG. 19, and/or one or more processors 1910 of the communications device 1900 in FIG. 19. Means for communicating, receiving or obtaining may include the one or more transceivers 324, one or more antennas 322, and/or processing system 316 of the UE 304 illustrated in FIG. 3, transceiver 1945 and/or antenna 1950 of the communications device 1900 in FIG. 19, and/or one or more processors 1910 of the communications device 1900 in FIG. 19.

### Example Clauses

Implementation examples are described in the following numbered clauses:

Clause 1: A method for wireless communications by a reader comprising: receiving, from a first IoT device, a first random access message; and sending, to the first IoT device, a second random access message that indicates: a first frequency shift for a transmission of a third random access message, wherein the first frequency shift is based on a first SNR associated with the first random access message; and a first bandwidth allocation for the transmission of the third random access message, wherein the first bandwidth allocation is based on the first frequency shift and the first SNR.

Clause 2: The method of Clause 1, wherein: receiving the first random access message comprises receiving a plurality of first random access messages from a plurality of IoT devices, the plurality of first random access messages from the plurality of IoT devices comprising at least the first random access message from the first IoT device and another first random access message from a second IoT device; the first bandwidth allocation is based on a respective SNR associated with each of the plurality of first random access messages, which includes at least: the first SNR associated with the first random access message from the first IoT device; and a second SNR associated with the other first random access message from the second IoT device.

Clause 3: The method of Clause 2, wherein: the first SNR is less than the second SNR; and the first frequency shift, for the transmission of the third random access message, is less than a second frequency shift for a transmission of another third random access message associated with the second IoT device.

Clause 4: The method of Clause 3, wherein: the first bandwidth allocation, for the transmission of the third random access message, is smaller than a second bandwidth allocation for the transmission of the other third random access message associated with the second IoT device.

Clause 5: The method of Clause 2, wherein: the first SNR is greater than the second SNR; and the first frequency shift, for the transmission of the third random access message, is greater than a second frequency shift for a transmission of another third random access message associated with the second IoT device.

Clause 6: The method of Clause 5, wherein: the first bandwidth allocation, for the transmission of the third random access message, is greater than a second bandwidth allocation for the transmission of the other third random access message associated with the second IoT device.

Clause 7: The method of Clause 2, further comprising: for each candidate frequency shift of a plurality of candidate frequency shifts for the transmission of the third random access message, and for each candidate bandwidth allocation of a plurality of candidate bandwidth allocations for the transmission of the third random access message: determining a respective interference to the first IoT device caused by one or more of the plurality of IoT devices; and determining the first frequency shift, among the plurality of candidate frequency shifts, and the first bandwidth allocation, among the plurality of candidate bandwidth allocations, for the transmission of the third random access message based on the respective interference associated with the first frequency shift and the first bandwidth allocation.

Clause 8: The method of Clause 2, wherein a first harmonic associated with a transmission of another third random access message associated with the second IoT device does not interfere with the transmission of the third random access message based on the first frequency shift and the first bandwidth allocation.

Clause 9: The method of Clause 2, further comprising: determining a SFO associated with at least another transmission of another third random access message that is associated with the second IoT device and that is based on a second frequency shift, wherein at least one of the first frequency shift or the first bandwidth allocation is further based on the SFO.

Clause 10: The method of any one of Clauses 1-9, wherein the second random access message further indicates at least one of: a coding rate for the transmission of the third random access message; a time domain resource allocation for the transmission of the third random access message; or an ID associated with the first IoT device.

Clause 11: The method of any one of Clauses 1-10, further comprising receiving, from the first IoT device, the third random access message based on the first frequency shift and in the first bandwidth allocation.

Clause 12: The method of Clause 11, wherein: the first random access message comprises a random access response; the second random access message comprises a grant of time and frequency resources for the transmission of the third random access message; and the third random access message comprises device information for the first IoT device.

Clause 13: The method of any one of Clauses 1-12, further comprising measuring the first SNR associated with the first random access message.

Clause 14: The method of any one of Clauses 1-13, further comprising sending, to the first IoT device, a waveform to activate the first IoT device to transmit the third random access message via backscattering.

Clause 15: A method for wireless communications by a first IoT device comprising: sending a first random access message; receiving a second random access message that indicates: a first frequency shift for a transmission of a third random access message, wherein the first frequency shift is based on a first SNR associated with the first random access message; and a first bandwidth allocation for the transmission of the third random access message, wherein the first bandwidth allocation is based on the first frequency shift and the first SNR; and sending the third random access message based on the first frequency shift and in the first bandwidth allocation.

Clause 16: The method of Clause 15, wherein the first bandwidth allocation is based on a respective SNR associated with each first random access message of a plurality of first random access messages associated with a plurality of IoT devices, which includes at least: the first SNR associated with the first random access message; and a second SNR associated with another first random access message from a second IoT device.

Clause 17: The method of Clause 16, wherein: the first SNR is less than the second SNR; and the first frequency shift, for the transmission of the third random access message, is less than a second frequency shift for a transmission of another third random access message associated with the second IoT device.

Clause 18: The method of Clause 17, wherein: the first bandwidth allocation, for the transmission of the third random access message, is smaller than a second bandwidth allocation for the transmission of the other third random access message associated with the second IoT device.

Clause 19: The method of Clause 16, wherein: the first SNR is greater than the second SNR; and the first frequency shift, for the transmission of the third random access message, is greater than a second frequency shift for a transmission of another third random access message associated with the second IoT device.

Clause 20: The method of Clause 19, wherein: the first bandwidth allocation, for the transmission of the third random access message, is greater than a second bandwidth allocation for the transmission of the other third random access message associated with the second IoT device.

Clause 21: The method of Clause 16, wherein a first harmonic associated with a transmission of another third random access message associated with the second IoT device does not interfere with the transmission of the third random access message based on the first frequency shift and in the first bandwidth allocation.

Clause 22: The method of Clause 16, wherein at least one of the first frequency shift or the first bandwidth allocation is further based on a SFO associated with at least another transmission of another third random access message that is associated with the second IoT device and that is based on a second frequency shift.

Clause 23: The method of any one of Clauses 15-22, wherein the second random access message further indicates at least one of: a coding rate for the transmission of the third random access message; a time domain resource allocation for the transmission of the third random access message; or an ID associated with the first IoT device.

Clause 24: The method of any one of Clauses 15-23, wherein: the first random access message comprises a random access response; the second random access message comprises a grant of time and frequency resources for the transmission of the third random access message; and the third random access message comprises device information for the first IoT device.

Clause 25: The method of any one of Clauses 15-24, further comprising receiving a waveform that activates the first IoT device to transmit the third random access message via backscattering, wherein sending the third random access message comprises sending the third random access message via the backscattering based on the waveform.

Clause 26: One or more apparatuses, comprising: one or more memories comprising executable instructions; and one or more processors configured to execute the executable instructions and cause the one or more apparatuses to perform a method in accordance with any one of Clauses 1-25.

Clause 27: One or more apparatuses configured for wireless communications, comprising: one or more memories; and one or more processors, coupled to the one or more memories, configured to cause the one or more apparatuses to perform a method in accordance with any one of Clauses 1-25.

Clause 28: One or more apparatuses configured for wireless communications, comprising: one or more memories; and one or more processors, coupled to the one or more memories, configured to perform a method in accordance with any one of Clauses 1-25.

Clause 29: One or more apparatuses, comprising means for performing a method in accordance with any one of Clauses 1-25.

Clause 30: One or more non-transitory computer-readable media comprising executable instructions that, when executed by one or more processors of one or more apparatuses, cause the one or more apparatuses to perform a method in accordance with any one of Clauses 1-25.

Clause 31: One or more computer program products embodied on one or more computer-readable storage media comprising code for performing a method in accordance with any one of Clauses 1-25.

Clause 32: One or more apparatuses configured for wireless communications, comprising: a processing system that includes one or more processors and one or more memories coupled with the one or more processors, the processing system configured to cause the one or more apparatuses to perform a method in accordance with any one of Clauses 1-25.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a reader to:
receive, from a first internet-of-things (IoT) device, a first random access message; and
send, to the first IoT device, a second random access message that indicates:
a first frequency shift for a transmission of a third random access message, wherein the first frequency shift is based on a first signal-to-noise ratio (SNR) associated with the first random access message; and
a first bandwidth allocation for the transmission of the third random access message, wherein the first bandwidth allocation is based on the first frequency shift and the first SNR.

2. The apparatus of claim 1, wherein:
to cause the reader to receive the first random access message, the processing system is configured to cause the reader to receive a plurality of first random access messages from a plurality of IoT devices, the plurality of first random access messages from the plurality of IoT devices comprising at least the first random access message from the first IoT device and another first random access message from a second IoT device; and
the first bandwidth allocation is based on a respective SNR associated with each of the plurality of first random access messages, which includes at least:
the first SNR associated with the first random access message from the first IoT device; and
a second SNR associated with the other first random access message from the second IoT device.

3. The apparatus of claim 2, wherein:
the first SNR is less than the second SNR; and
the first frequency shift, for the transmission of the third random access message, is less than a second frequency shift for a transmission of another third random access message associated with the second IoT device.

4. The apparatus of claim 3, wherein:
the first bandwidth allocation, for the transmission of the third random access message, is smaller than a second bandwidth allocation for the transmission of the other third random access message associated with the second IoT device.

5. The apparatus of claim 2, wherein:
the first SNR is greater than the second SNR; and
the first frequency shift, for the transmission of the third random access message, is greater than a second frequency shift for a transmission of another third random access message associated with the second IoT device.

6. The apparatus of claim 5, wherein:
the first bandwidth allocation, for the transmission of the third random access message, is greater than a second bandwidth allocation for the transmission of the other third random access message associated with the second IoT device.

7. The apparatus of claim 2, wherein the processing system is configured to cause the reader to:
for each candidate frequency shift of a plurality of candidate frequency shifts for the transmission of the third random access message, and for each candidate bandwidth allocation of a plurality of candidate bandwidth allocations for the transmission of the third random access message:
determine a respective interference to the first IoT device caused by one or more of the plurality of IoT devices; and
determine the first frequency shift, among the plurality of candidate frequency shifts, and the first bandwidth allocation, among the plurality of candidate bandwidth allocations, for the transmission of the third random access message based on the respective interference associated with the first frequency shift and the first bandwidth allocation.

8. The apparatus of claim 2, wherein a first harmonic associated with a transmission of another third random access message associated with the second IoT device does not interfere with the transmission of the third random access message based on the first frequency shift and the first bandwidth allocation.

9. The apparatus of claim 2, wherein:
the processing system is configured to cause the reader to:
determine a sampling frequency offset (SFO) associated with at least another transmission of another third random access message that is associated with the second IoT device and that is based on a second frequency shift,
wherein at least one of the first frequency shift or the first bandwidth allocation is further based on the SFO.

10. The apparatus of claim 1, wherein the second random access message further indicates at least one of:
a coding rate for the transmission of the third random access message;
a time domain resource allocation for the transmission of the third random access message; or
an identifier (ID) associated with the first IoT device.

11. The apparatus of claim 1, wherein the processing system is configured to cause the reader to receive, from the first IoT device, the third random access message based on the first frequency shift and in the first bandwidth allocation.

12. The apparatus of claim 11, wherein:
the first random access message comprises a random access response;
the second random access message comprises a grant of time and frequency resources for the transmission of the third random access message; and
the third random access message comprises device information for the first IoT device.

13. The apparatus of claim 1, wherein the processing system is configured to cause the reader to measure the first SNR associated with the first random access message.

14. The apparatus of claim 1, wherein the processing system is configured to cause the reader to send, to the first IoT device, a waveform to activate the first IoT device to transmit the third random access message via backscattering.

15. A method of wireless communications by a reader, comprising:
receiving, from a first internet-of-things (IoT) device, a first random access message; and
sending, to the first IoT device, a second random access message that indicates:
a first frequency shift for a transmission of a third random access message, wherein the first frequency shift is based on a first signal-to-noise ratio (SNR) associated with the first random access message; and
a first bandwidth allocation for the transmission of the third random access message, wherein the first bandwidth allocation is based on the first frequency shift and the first SNR.

16. The method of claim 15, wherein:
receiving the first random access message comprises receiving a plurality of first random access messages from a plurality of IoT devices, the plurality of first random access messages from the plurality of IoT devices comprising at least the first random access message from the first IoT device and another first random access message from a second IoT device; and
the first bandwidth allocation is based on a respective SNR associated with each of the plurality of first random access messages, which includes at least:
the first SNR associated with the first random access message from the first IoT device; and
a second SNR associated with the other first random access message from the second IoT device.

17. The method of claim 16, wherein:
the first SNR is less than the second SNR; and
the first frequency shift, for the transmission of the third random access message, is less than a second frequency shift for a transmission of another third random access message associated with the second IoT device.

18. The method of claim 17, wherein:
the first bandwidth allocation, for the transmission of the third random access message, is smaller than a second bandwidth allocation for the transmission of the other third random access message associated with the second IoT device.

19. The method of claim 16, wherein:
the first SNR is greater than the second SNR; and
the first frequency shift, for the transmission of the third random access message, is greater than a second frequency shift for a transmission of another third random access message associated with the second IoT device.

20. One or more non-transitory computer-readable media comprising executable instructions that, when executed by one or more processors of an apparatus, cause the apparatus to perform operations comprising:
receiving, from a first internet-of-things (IoT) device, a first random access message; and
sending, to the first IoT device, a second random access message that indicates:
a first frequency shift for a transmission of a third random access message, wherein the first frequency shift is based on a first signal-to-noise ratio (SNR) associated with the first random access message; and
a first bandwidth allocation for the transmission of the third random access message, wherein the first bandwidth allocation is based on the first frequency shift and the first SNR.
